(19) United States
(12) Patent Application Publication
(10) Pub. No.: US 2021/0170729 A1
(43) Pub. Date: Jun. 10, 2021

(54) LAMINATE

(71) Applicant: NITTO DENKO CORPORATION, Osaka (JP)

(72) Inventors: Hiromichi SUMIDA, Ibaraki-shi (JP); Takuya FUJITA, Ibaraki-shi (JP); Masahito NIWA, Ibaraki-shi (JP)

(73) Assignee: NITTO DENKO CORPORATION, Osaka (JP)

(21) Appl. No.: 17/075,886

(22) Filed: Oct. 21, 2020

(30) Foreign Application Priority Data
Dec. 5, 2019 (JP) 2019-220483

(51) Int. Cl. B32B 27/08; B32B 7/12; C09J 7/38; B32B 27/40; B32B 27/36; B32B 15/095; B32B 15/20

(52) U.S. Cl. CPC B32B 27/08; B32B 2405/00; C09J 7/385; B32B 27/40; B32B 27/365; B32B 15/095; B32B 15/20; B32B 2250/03; B32B 2307/54; B32B 2307/546; B32B 2307/544; B32B 2311/24; B32B 2367/00; B32B 2369/00; B32B 2333/12; B32B 2375/00; B32B 7/12

(57) ABSTRACT

A laminate including a laminated structure of a pressure-sensitive adhesive sheet, a reinforcing agent layer, and an adherend. The laminate expresses both of a high adhesive strength and high impact resistance. The laminate shows an adhesive strength of 20 N/20 mm or more when the pressure-sensitive adhesive sheet is peeled from a laminated structural body where the adherend is a SUS plate, the laminate shows an adhesive strength of 20 N/20 mm or more when the pressure-sensitive adhesive sheet is peeled from a laminated structural body where the adherend is a polycarbonate plate, and the laminate shows an adhesive strength of 20 N/20 mm or more when the pressure-sensitive adhesive sheet is peeled from a laminated structural body where the adherend is an aluminum plate at 23° C. and 50% RH, and at a tensile rate of 300 mm/min and a peel angle of 180°.

### BACKGROUND OF THE INVENTION

### 1. Field of the Invention

The present invention relates to a laminate. The present invention typically relates to a laminate including a laminated structure of a pressure-sensitive adhesive sheet, a reinforcing agent layer, and an adherend.

### 2. Description of the Related Art

In recent years, along with a trend of the sophistication of various kinds of performance of a mobile device, the sophistication of various kinds of performance of various constituent members adopted in the mobile device has been required. In the mobile device, a pressure-sensitive adhesive sheet is sometimes adopted for the bonding of a casing or the like. The sophistication of various kinds of performance of the pressure-sensitive adhesive sheet has also been required in recent years, and various investigations have been made (e.g., Japanese Patent Application Laid-open No. 2019-147851).

When the pressure-sensitive adhesive sheet to be used for the mobile device does not have a high adhesive strength, the sheet peels off during its use to cause a failure or the like. In particular, in, for example, the case where the pressure-sensitive adhesive sheet is adopted for the bonding of the casing or the like, various adherends, such as SUS, polycarbonate, and aluminum, are conceivable as the adherend of the pressure-sensitive adhesive sheet. In view of the foregoing, a pressure-sensitive adhesive sheet having strong adhesive strengths for such various adherends that may be used for the mobile device has been required.

In addition, there is a risk in that the mobile device falls depending on its usage form. Accordingly, a mobile device having high impact resistance has been required. To improve the impact resistance of the mobile device, a shock-absorbing member may be arranged outside its casing. In such form, however, the size of the mobile device may increase, or the design property thereof may be impaired.

In view of the foregoing, it has been desired to impart excellent impact resistance to the pressure-sensitive adhesive sheet that may be arranged in the mobile device.

A double-sided pressure-sensitive adhesive sheet having impact resistance has been recently reported (Japanese Patent Application Laid-open No. 2015-120876). The double-sided pressure-sensitive adhesive sheet includes, as an essential constituent, a foam base material for expressing its impact resistance. However, when the foam is elongated to a certain extent or more, or a force is applied thereto, the foam breaks to have a smaller area or to become thinner. As a result, there occurs a problem in that the cell portions of the foam occupy a large part of the adhesion portion of the sheet to reduce the adhesive property thereof.

Therefore, the pressure-sensitive adhesive sheet to be used for the mobile device is required to have both of high adhesive strengths for various adherends that may be used for the mobile device and high impact resistance. However, the related-art pressure-sensitive adhesive sheet alone cannot achieve both of those properties, and hence there is a demand for a technology that enables expression of both of high adhesive strengths for various adherends that may be used for the mobile device and high impact resistance.

### SUMMARY OF THE INVENTION

An object of the present invention is to provide a laminate including a laminated structure of a pressure-sensitive adhesive sheet, a reinforcing agent layer, and an adherend, the laminate being capable of expressing both of a high adhesive strength and high impact resistance.

According to at least one embodiment of the present invention, there is provided a laminate, including a laminated structure of a pressure-sensitive adhesive sheet, a reinforcing agent layer, and an adherend, wherein an outermost layer of the pressure-sensitive adhesive sheet on a reinforcing agent layer side is a pressure-sensitive adhesive layer, wherein the laminate shows an adhesive strength of 20 N/20 mm or more when the pressure-sensitive adhesive sheet is peeled from a laminated structural body of the pressure-sensitive adhesive sheet, the reinforcing agent layer, and a SUS plate at 23° C. and 50% RH, and at a tensile rate of 300 mm/min and a peel angle of 180°, wherein the laminate shows an adhesive strength of 20 N/20 mm or more when the pressure-sensitive adhesive sheet is peeled from a laminated structural body of the pressure-sensitive adhesive sheet, the reinforcing agent layer, and a polycarbonate plate at 23° C. and 50% RH, and at a tensile rate of 300 mm/min and a peel angle of 180°, wherein the laminate shows an adhesive strength of 20 N/20 mm or more when the pressure-sensitive adhesive sheet is peeled from a laminated structural body of the pressure-sensitive adhesive sheet, the reinforcing agent layer, and an aluminum plate at 23° C. and 50% RH, and at a tensile rate of 300 mm/min and a peel angle of 180°, and wherein the laminated structural body of the pressure-sensitive adhesive sheet, the reinforcing agent layer, and the SUS plate shows an impact resistance of 0.35 J or more at 23° C. and 50% RH.

In at least one embodiment of the present invention, the pressure-sensitive adhesive layer serving as the outermost layer of the pressure-sensitive adhesive sheet on the reinforcing agent layer side is formed from a pressure-sensitive adhesive composition, the pressure-sensitive adhesive composition contains at least one kind selected from the group consisting of a monomer composition (M) and a polymer component (P) obtained from the monomer composition (M), and the monomer composition (M) contains 50 wt % or more of a (meth)acrylic acid ester having an alkyl ester having 1 to 12 carbon atoms, and contains 1 wt % to 10 wt % of (meth)acrylic acid.

In at least one embodiment of the present invention, the monomer composition (M) contains 85 wt % or more of the (meth)acrylic acid ester having the alkyl ester having 1 to 12 carbon atoms.

In at least one embodiment of the present invention, the (meth)acrylic acid ester having the alkyl ester having 1 to 12 carbon atoms is n-butyl acrylate.

In at least one embodiment of the present invention, the pressure-sensitive adhesive sheet has a thickness of from 100 μm to 400 μm.

In at least one embodiment of the present invention, the reinforcing agent layer has a thickness of from 0.10 μm to 4.00 μm.

In at least one embodiment of the present invention, the reinforcing agent layer is formed from a reinforcing agent, and the reinforcing agent contains an aqueous urethane resin bonded by an isocyanate-based cross-linking agent, the resin having at least one kind selected from the group consisting of an ester skeleton, an ether skeleton, and a carbonate skeleton.

In at least one embodiment of the present invention, the aqueous urethane resin has an elongation of from 300% to 1,000%.

In at least one embodiment of the present invention, the aqueous urethane resin is a nonreactive aqueous urethane resin.

In at least one embodiment of the present invention, the nonreactive aqueous urethane resin is a self-emulsifying aqueous urethane resin.

In at least one embodiment of the present invention, the adherend is an electronic device member.

In at least one embodiment of the present invention, a material for an adhesion site of the adherend is at least one kind selected from the group consisting of SUS, polycarbonate, aluminum, a polyolefin-based resin, a styrene-based resin, a polyester-based resin, an acrylic resin, a polyimide-based resin, and a glass fiber.

In at least one embodiment of the present invention, the laminate according to at least one embodiment of the present invention is used for an electronic device.

According to at least one embodiment of the present invention, there is provided a mobile electronic device, including the laminate according to at least one embodiment of the present invention.

### BRIEF DESCRIPTION OF THE DRAWINGS

FIG. 1 is a schematic sectional view of a laminate according to at least one embodiment of the present invention.

FIG. 2 is a schematic sectional view of a laminate according to at least one embodiment of the present invention.

### DESCRIPTION OF THE EMBODIMENTS

As used herein, the term “(meth)acryl” means at least one kind selected from the group consisting of an acryl and a methacryl, and the term “(meth)acrylate” means at least one kind selected from the group consisting of an acrylate and a methacrylate.

<<<<1. Laminate>>>>

A laminate according to at least one embodiment of the present invention is a laminate including a laminated structure of a pressure-sensitive adhesive sheet, a reinforcing agent layer, and an adherend, and the outermost layer of the pressure-sensitive adhesive sheet on the reinforcing agent layer side is a pressure-sensitive adhesive layer.

The laminate according to at least one embodiment of the present invention may include any appropriate other layer to such an extent that the effect of the present invention is not impaired as long as the laminate includes the laminated structure of the pressure-sensitive adhesive sheet, the reinforcing agent layer, and the adherend.

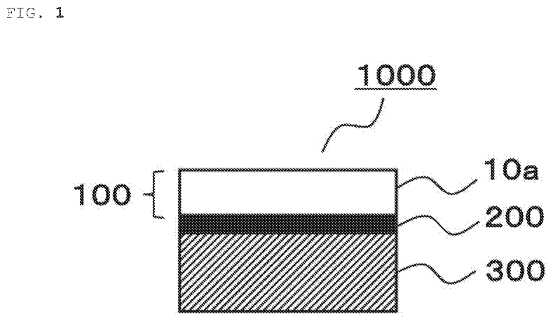

FIG. 1 is a schematic sectional view of the laminate according to at least one embodiment of the present invention. In FIG. 1, a laminate 1000 is formed of a pressure-sensitive adhesive sheet 100, a reinforcing agent layer 200, and an adherend 300. The outermost layer of the pressure-sensitive adhesive sheet 100 on the reinforcing agent layer 200 side is a pressure-sensitive adhesive layer 10a. FIG. 1 is an illustration of an embodiment in which the entirety of the pressure-sensitive adhesive sheet 100 is the pressure-sensitive adhesive layer 10a.

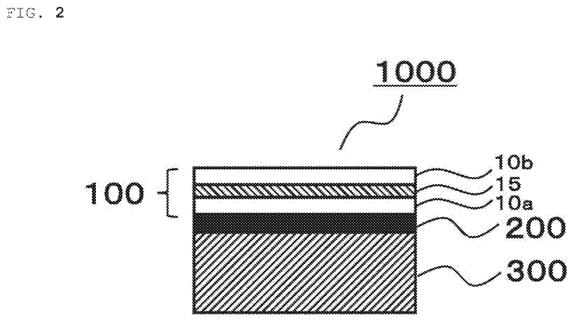

FIG. 2 is a schematic sectional view of the laminate according to at least one embodiment of the present invention. In FIG. 2, the laminate 1000 is formed of the pressure-sensitive adhesive sheet 100, the reinforcing agent layer 200, and the adherend 300, and the pressure-sensitive adhesive sheet 100 is formed of three layers, that is, a pressure-sensitive adhesive layer 10b, a base material layer 15, and the pressure-sensitive adhesive layer 10a.

The laminate according to at least one embodiment of the present invention shows an adhesive strength of 20 N/20 mm or more, preferably 23 N/20 mm or more, more preferably 25 N/20 mm or more, still more preferably 28 N/20 mm or more, particularly preferably 34 N/20 mm or more when the pressure-sensitive adhesive sheet and the reinforcing agent layer, which are constituent materials for the laminate according to at least one embodiment of the present invention, are laminated together with a SUS plate to prepare a laminated structural body of the pressure-sensitive adhesive sheet, the reinforcing agent layer, and the SUS plate, and the laminated structural body is aged at 23° C. and 50% RH for 30 minutes, followed by the peeling of the pressure-sensitive adhesive sheet at 23° C. and 50% RH, and at a tensile rate of 300 mm/min and a peel angle of 180°. In the case where the adhesive strength is so low as to deviate from the ranges, it may be impossible to provide a laminate that can express a high adhesive strength. The upper limit of the adhesive strength is preferably 60 N/20 mm or less. In the case where the adhesive strength is so high as to deviate from the ranges, when a member is disassembled at the time of the repair of a mobile device, the pressure-sensitive adhesive sheet cannot be peeled from the laminated structural body while the member maintains its normal state, and hence the member may be damaged or it may be impossible to repair the device.

The laminate according to at least one embodiment of the present invention shows an adhesive strength of 20 N/20 mm or more, preferably 23 N/20 mm or more, more preferably 28 N/20 mm or more, still more preferably 31 N/20 mm or more, particularly preferably 34 N/20 mm or more when the pressure-sensitive adhesive sheet and the reinforcing agent layer, which are constituent materials for the laminate according to at least one embodiment of the present invention, are laminated together with a polycarbonate plate to prepare a laminated structural body of the pressure-sensitive adhesive sheet, the reinforcing agent layer, and the polycarbonate plate, and the laminated structural body is aged at 23° C. and 50% RH for 30 minutes, followed by the peeling of the pressure-sensitive adhesive sheet at 23° C. and 50% RH, and at a tensile rate of 300 mm/min and a peel angle of 180°. In the case where the adhesive strength is so low as to deviate from the ranges, it may be impossible to provide a laminate that can express a high adhesive strength. The upper limit of the adhesive strength is preferably 60 N/20 mm or less. In the case where the adhesive strength is so high as to deviate from the ranges, when a member is disassembled at the time of the repair of a mobile device, the pressure-sensitive adhesive sheet cannot be peeled from the laminated structural body while the member maintains its normal state, and hence the member may be damaged or it may be impossible to repair the device.

The laminate according to at least one embodiment of the present invention shows an adhesive strength of 20 N/20 mm or more, preferably 24 N/20 mm or more, more preferably 28 N/20 mm or more, still more preferably 31 N/20 mm or more, particularly preferably 34 N/20 mm or more when the pressure-sensitive adhesive sheet and the reinforcing agent layer, which are constituent materials for the laminate according to at least one embodiment of the present invention, are laminated together with an aluminum plate to prepare a laminated structural body of the pressure-sensitive adhesive sheet, the reinforcing agent layer, and the aluminum plate, and the laminated structural body is aged at 23° C. and 50% RH for 30 minutes, followed by the peeling of the pressure-sensitive adhesive sheet at 23° C. and 50% RH, and at a tensile rate of 300 mm/min and a peel angle of 180°. In the case where the adhesive strength is so low as to deviate from the ranges, it may be impossible to provide a laminate that can express a high adhesive strength. The upper limit of the adhesive strength is preferably 60 N/20 mm or less. In the case where the adhesive strength is so high as to deviate from the ranges, when a member is disassembled at the time of the repair of a mobile device, the pressure-sensitive adhesive sheet cannot be peeled from the laminated structural body while the member maintains its normal state, and hence the member may be damaged or it may be impossible to repair the device.

When (1) the adhesive strength of the laminate according to at least one embodiment of the present invention when the pressure-sensitive adhesive sheet is peeled from the laminated structural body of the pressure-sensitive adhesive sheet, the reinforcing agent layer, and the SUS plate at a tensile rate of 300 mm/min and a peel angle of 180°, (2) the adhesive strength thereof when the pressure-sensitive adhesive sheet is peeled from the laminated structural body of the pressure-sensitive adhesive sheet, the reinforcing agent layer, and the polycarbonate plate at a tensile rate of 300 mm/min and a peel angle of 180°, and (3) the adhesive strength thereof when the pressure-sensitive adhesive sheet is peeled from the laminated structural body of the pressure-sensitive adhesive sheet, the reinforcing agent layer, and the aluminum plate at a tensile rate of 300 mm/min and a peel angle of 180° fall within the above-mentioned ranges at 23° C. and 50% RH as described above, there can be provided a laminate including a laminated structure of a pressure-sensitive adhesive sheet, a reinforcing agent layer, and an adherend, the laminate being capable of expressing a high adhesive strength.

The laminate according to at least one embodiment of the present invention is such that when the pressure-sensitive adhesive sheet and the reinforcing agent layer, which are constituent materials for the laminate according to at least one embodiment of the present invention, are laminated together with a SUS plate to prepare a laminated structural body of the pressure-sensitive adhesive sheet, the reinforcing agent layer, and the SUS plate, and its impact resistance is measured at 23° C. and 50% RH, the impact resistance is 0.35 J or more, preferably 0.36 J or more, more preferably 0.41 J or more, still more preferably 0.47 J or more, particularly preferably 0.52 J or more. When the impact resistance is so low as to deviate from the ranges, it may be impossible to provide a laminate that can express high impact resistance.

When the laminate according to at least one embodiment of the present invention is such that the impact resistance of the laminated structural body of the pressure-sensitive adhesive sheet, the reinforcing agent layer, and the SUS plate at 23° C. and 50% RH falls within the above-mentioned ranges as described above, there can be provided a laminate including a laminated structure of a pressure-sensitive adhesive sheet, a reinforcing agent layer, and an adherend, the laminate being capable of expressing high impact resistance.

The laminate according to at least one embodiment of the present invention is typically used for an electronic device.

In addition, a mobile electronic device including the laminate according to at least one embodiment of the present invention serves as a mobile electronic device according to at least one embodiment of the present invention.

<<1-1. Pressure-Sensitive Adhesive Sheet>>

The pressure-sensitive adhesive sheet may adopt any appropriate configuration to such an extent that the effect of the present invention is not impaired as long as at least one outermost layer thereof is the pressure-sensitive adhesive layer.

The pressure-sensitive adhesive sheet may be such a base material-less pressure-sensitive adhesive sheet formed only of the pressure-sensitive adhesive layer 10a as illustrated in FIG. 1, or may be a base material-including pressure-sensitive adhesive sheet including a base material layer. For example, the base material-including pressure-sensitive adhesive sheet may be such a double-sided pressure-sensitive adhesive sheet formed of three layers, that is, the pressure-sensitive adhesive layer 10b, the base material layer 15, and the pressure-sensitive adhesive layer 10a as illustrated in FIG. 2, or may be a single-sided pressure-sensitive adhesive sheet including its pressure-sensitive adhesive layer only on one side of its base material layer.

The pressure-sensitive adhesive layers may be used alone or in combination thereof. When the pressure-sensitive adhesive layer is a laminate of two or more layers, its interface may be observed by, for example, the differential interference method of LEXT OLS 4000 manufactured by Olympus Corporation.

The thickness of the pressure-sensitive adhesive sheet is preferably 100 μm or more because the effect of the present invention can be further expressed, and the thickness is more preferably from 150 μm to 2,000 μm, still more preferably from 150 μm to 1,000 μm, particularly preferably from 150 μm to 550 μm, particularly preferably from 150 μm to 400 μm.

Any appropriate release liner may be arranged on the surface of the pressure-sensitive adhesive layer for, for example, protecting the laminate until the laminate is used to such an extent that the effect of the present invention is not impaired. Examples of the release liner include: a release liner obtained by subjecting the surface of a base material (liner base material), such as paper or a plastic film, to a silicone treatment; and a release liner obtained by laminating a polyolefin-based resin on the surface of a base material (liner base material), such as paper or a plastic film. Examples of the plastic film serving as the liner base material include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film. The plastic film serving as the liner base material is preferably a polyethylene film.

The thickness of the release liner is preferably from 1 μm to 500 μm, more preferably from 3 μm to 450 μm, still more preferably from 5 μm to 400 μm, particularly preferably from 10 μm to 300 μm.

<1-1-1. Pressure-Sensitive Adhesive Layer>

The pressure-sensitive adhesive layer is formed from a pressure-sensitive adhesive composition.

The pressure-sensitive adhesive layer is formed from the pressure-sensitive adhesive composition by any appropriate method. Examples of such method include: a method (direct method) involving applying the pressure-sensitive adhesive composition serving as a formation material for the pressure-sensitive adhesive layer onto any appropriate base material (e.g., a base material film), and drying the composition as required, to form the pressure-sensitive adhesive layer on the base material; and a method (transfer method) involving applying the pressure-sensitive adhesive composition to a surface having releasability (release surface), and drying the composition as required, to form the pressure-sensitive adhesive layer on the surface having releasability (release surface), and transferring the pressure-sensitive adhesive layer onto any appropriate base material (e.g., a base material film). The surface having releasability (release surface) is, for example, the surface of the release liner described in the foregoing.

Any appropriate application method may be adopted as a method of applying the pressure-sensitive adhesive composition to such an extent that the effect of the present invention is not impaired. Examples of such application method include roll coating, gravure coating, reverse coating, roll brushing, spray coating, an air knife coating method, and extrusion coating with a die coater or the like. Active energy ray irradiation, such as UV irradiation, may be performed for curing an applied layer formed by the application.

The drying of the pressure-sensitive adhesive composition may be performed under heating from the viewpoints of, for example, the acceleration of the cross-linking reaction of the composition and an improvement in production efficiency of the laminate. A drying temperature may be typically set to, for example, from 40° C. to 150° C., and is preferably from 60° C. to 130° C. After the drying of the pressure-sensitive adhesive composition, aging may be further performed for the purposes of, for example, adjusting the migration of a component in the pressure-sensitive adhesive layer, advancing the cross-linking reaction, and alleviating strain that may be present in the pressure-sensitive adhesive layer.

The thickness of the pressure-sensitive adhesive layer may be appropriately set in accordance with the thickness of a pressure-sensitive adhesive layer laminate to be finally formed and the number of the pressure-sensitive adhesive layers. The thickness of such pressure-sensitive adhesive layer is preferably 50 μm or more, more preferably from 50 μm to 2,000 μm, still more preferably from 100 μm to 1,000 μm, particularly preferably from 100 μm to 500 μm, most preferably from 150 μm to 300 μm.

Each of the XY-direction and Z-direction light transmittances of the pressure-sensitive adhesive layer is preferably 5% or less, more preferably 3% or less, still more preferably 1% or less, still more preferably 0.5% or less, particularly preferably 0.1% or less, most preferably 0.04% or less. When each of the XY-direction and Z-direction light transmittances of the pressure-sensitive adhesive layer falls within the ranges, the pressure-sensitive adhesive layer can exhibit an excellent light-shielding property. The XY-direction light transmittance of the pressure-sensitive adhesive layer is preferably 0.03% or less, more preferably 0.02% or less, still more preferably 0.01% or less. The Z-direction light transmittance of the pressure-sensitive adhesive layer is preferably 0.03% or less, more preferably 0.02% or less, still more preferably 0.01% or less.

The pressure-sensitive adhesive composition preferably contains at least one kind selected from the group consisting of a monomer composition (M) and a polymer component (P) obtained by the polymerization of the monomer composition (M). That is, typically, the pressure-sensitive adhesive composition may have any one of the following forms: a form that contains the polymer component (P) and is substantially free of the monomer composition (M) (form 1); a form that contains the monomer composition (M) and is substantially free of the polymer component (P) (form 2); and a form that contains both of the monomer composition (M) and the polymer component (P) (form 3).

The form that contains the polymer component (P) and is substantially free of the monomer composition (M) (form 1) is a form in which, at the stage of the preparation of the pressure-sensitive adhesive composition, the polymer component (P) is substantially formed by the polymerization of the monomer composition (M).

The form that contains the monomer composition (M) and is substantially free of the polymer component (P) (form 2) is a form in which, at the stage of the preparation of the pressure-sensitive adhesive composition, substantially no polymerization of the monomer composition (M) occurs, and hence the polymer component (P) has not been formed yet. In the form, the polymer component (P) may be formed by, for example, curing the applied layer formed by the application of the prepared pressure-sensitive adhesive composition through active energy ray irradiation, such as UV irradiation.

The form that contains both of the monomer composition (M) and the polymer component (P) (form 3) is a form in which, at the stage of the preparation of the pressure-sensitive adhesive composition, part of the monomers of the monomer composition (M) are polymerized to form a partial polymer, and the monomers of the monomer composition (M) that are unreacted remain. In the form, the polymer component (P) may be formed by, for example, curing the applied layer formed by the application of the prepared pressure-sensitive adhesive composition through active energy ray irradiation, such as UV irradiation.

In the case of the form 1 (form that contains the polymer component (P) and is substantially free of the monomer composition (M)), the content of the polymer component (P) in the pressure-sensitive adhesive composition is as follows: when the total amount of the pressure-sensitive adhesive composition is set to 100 parts by weight, the content of the polymer component (P) is preferably from 50 wt % to 100 wt %, more preferably from 60 wt % to 100 wt %, still more preferably from 70 wt % to 100 wt %, particularly preferably from 80 wt % to 100 wt %.

In the case of the form 2 (form that contains the monomer composition (M) and is substantially free of the polymer component (P)), the content of the monomer composition (M) in the pressure-sensitive adhesive composition is as follows: when the total amount of the pressure-sensitive adhesive composition is set to 100 parts by weight, the content of the monomer composition (M) is preferably from 50 wt % to 100 wt %, more preferably from 60 wt % to 100 wt %, still more preferably from 70 wt % to 100 wt %, particularly preferably from 80 wt % to 100 wt %.

In the case of the form 3 (form that contains both of the monomer composition (M) and the polymer component (P)), the total content of the polymer component (P) and the monomer composition (M) in the pressure-sensitive adhesive composition is as follows: when the total amount of the pressure-sensitive adhesive composition is set to 100 parts by weight, the total content of the polymer component (P) and the monomer composition (M) is preferably from 50 wt % to 100 wt %, more preferably from 60 wt % to 100 wt %, still more preferably from 70 wt % to 100 wt %, particularly preferably from 80 wt % to 100 wt %.

It is preferred that the monomer composition (M) contain 50 wt % or more of a (meth)acrylic acid ester having an alkyl ester having 1 to 12 carbon atoms, and contain 1 wt % to 10 wt % of (meth)acrylic acid because the effect of the present invention can be further expressed. The term “(meth)acrylic acid ester having an alkyl ester having 1 to 12 carbon atoms” as used herein does not include an alicyclic structure-containing acrylic monomer to be described later.

The content of the (meth)acrylic acid ester having the alkyl ester having 1 to 12 carbon atoms in the monomer composition (M) is preferably from 50 wt % to 100 wt %, more preferably from 75 wt % to 99.5 wt %, still more preferably from 85 wt % to 99 wt %, still more preferably from 86 wt % to 98 wt %, still more preferably from 87 wt % to 98 wt %, still more preferably from 88 wt % to 97 wt %, still more preferably from 89 wt % to 97 wt %, still more preferably from 90 wt % to 97 wt %, still more preferably from 91 wt % to 97 wt %, particularly preferably from 92 wt % to 97 wt %, most preferably from 93 wt % to 97 wt %. When the content of the (meth)acrylic acid ester having the alkyl ester having 1 to 12 carbon atoms in the monomer composition (M) is adjusted within the ranges, there can be provided a laminate including a laminated structure of a pressure-sensitive adhesive sheet, a reinforcing agent layer, and an adherend, the laminate being capable of expressing both of a higher adhesive strength and higher impact resistance.

Examples of the (meth)acrylic acid ester having the alkyl ester having 1 to 12 carbon atoms include methyl (meth)acrylate, ethyl (meth)acrylate, propyl (meth)acrylate, n-butyl (meth)acrylate, isobutyl (meth)acrylate, s-butyl (meth)acrylate, t-butyl (meth)acrylate, pentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth) acrylate, isononyl (meth) acrylate, decyl (meth) acrylate, isodecyl (meth)acrylate, undecyl (meth)acrylate, and dodecyl (meth)acrylate. Of those, n-butyl acrylate is preferred because the effect of the present invention can be further expressed.

Therefore, when n-butyl acrylate is adopted as the (meth)acrylic acid ester having the alkyl ester having 1 to 12 carbon atoms, the content of n-butyl acrylate in the monomer composition (M) is preferably from 50 wt % to 100 wt %, more preferably from 75 wt % to 99.5 wt %, still more preferably from 85 wt % to 99 wt %, still more preferably from 86 wt % to 98 wt %, still more preferably from 87 wt % to 98 wt %, still more preferably from 88 wt % to 97 wt %, still more preferably from 89 wt % to 97 wt %, still more preferably from 90 wt % to 97 wt %, still more preferably from 91 wt % to 97 wt %, particularly preferably from 92 wt % to 97 wt %, most preferably from 93 wt % to 97 wt %. When the content of n-butyl acrylate in the monomer composition (M) is adjusted within the ranges, there can be provided a laminate including a laminated structure of a pressure-sensitive adhesive sheet, a reinforcing agent layer, and an adherend, the laminate being capable of expressing both of a higher adhesive strength and higher impact resistance.

The content of (meth)acrylic acid in the monomer composition (M) is preferably from 1 wt % to 10 wt %, more preferably from 1 wt % to 8 wt %, still more preferably from 2 wt % to 7 wt %, still more preferably from 2 wt % to 6 wt %, particularly preferably from 2.5 wt % to 5.5 wt %, most preferably from 3 wt % to 5.5 wt %. When the content of (meth)acrylic acid in the monomer composition (M) is adjusted within the ranges, there can be provided a laminate including a laminated structure of a pressure-sensitive adhesive sheet, a reinforcing agent layer, and an adherend, the laminate being capable of expressing both of a higher adhesive strength and higher impact resistance.

The monomer composition (M) may contain any other monomer. Such other monomers may be used alone or in combination thereof.

The content of the other monomer in the total amount of the monomer composition (M) is preferably from 0 wt % to 10 wt %, more preferably from 0 wt % to 8 wt %, still more preferably from 0 wt % to 6 wt %, particularly preferably from 0 wt % to 4 wt %, most preferably from 0 wt % to 2 wt %. When the content of the other monomer in the monomer composition (M) is adjusted within the ranges, there can be provided a laminate including a laminated structure of a pressure-sensitive adhesive sheet, a reinforcing agent layer, and an adherend, the laminate being capable of expressing both of a higher adhesive strength and higher impact resistance.

Examples of the other monomer include an alicyclic structure-containing acrylic monomer, a hydroxy group-containing monomer, a carboxyl group-containing monomer except (meth)acrylic acid, a nitrogen-based cyclic structure-containing monomer, a cyclic ether group-containing monomer, a glycol-based acrylic ester monomer, a styrene-based monomer, an amide group-containing monomer, an amino group-containing monomer, an imide group-containing monomer, a vinyl ether monomer, a silane-based monomer, and a polyfunctional monomer.

The alicyclic structure-containing acrylic monomer is preferably an acrylic monomer having a cyclic aliphatic hydrocarbon structure. The number of carbon atoms of the cyclic aliphatic hydrocarbon structure is preferably 3 or more, more preferably from 6 to 24, still more preferably from 6 to 18, particularly preferably from 6 to 12. Specific examples of such alicyclic structure-containing acrylic monomer include cyclopropyl (meth)acrylate, cyclobutyl (meth)acrylate, cyclopentyl (meth)acrylate, cyclohexyl (meth)acrylate, cycloheptyl (meth)acrylate, cyclooctyl (meth)acrylate, isobornyl (meth)acrylate, and dicyclopentanyl (meth)acrylate.

Specific examples of the hydroxy group-containing monomer include: hydroxyalkyl (meth)acrylates, such as 2-hydroxybutyl (meth)acrylate, 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, and 12-hydroxylauryl (meth)acrylate; hydroxyalkylcycloalkane (meth)acrylates, such as (4-hydroxymethylcyclohexyl)methyl (meth)acrylate; and other hydroxy group-containing monomers, such as hydroxyethyl (meth)acrylamide, allyl alcohol, 2-hydroxyethyl vinyl ether, 4-hydroxybutyl vinyl ether, and diethylene glycol monovinyl ether. Of those hydroxy group-containing monomers, a hydroxyalkyl (meth)acrylate is preferred because more excellent impact resistance can be expressed, and a hydroxyalkyl (meth)acrylate having a hydroxyalkyl group having 2 to 6 carbon atoms is more preferred, and 2-hydroxyethyl (meth)acrylate or 4-hydroxybutyl (meth)acrylate is still more preferred.

Specific examples of the carboxyl group-containing monomer except (meth)acrylic acid include carboxyethyl (meth)acrylate, carboxypentyl (meth)acrylate, itaconic acid, maleic acid, fumaric acid, crotonic acid, and isocrotonic acid.

Specific examples of the nitrogen-based cyclic structure-containing monomer include: lactam-based vinyl monomers, such as N-vinylpyrrolidone, N-vinyl-ε-caprolactam, and methyl vinylpyrrolidone; vinyl-based monomers each having a nitrogen-containing heterocycle, such as vinylpyridine, vinylpiperidone, vinylpyrimidine, vinylpiperazine, vinylpyrazine, vinylpyrrole, vinylimidazole, vinyloxazole, and vinylmorpholine; and (meth)acrylic monomers each containing a heterocycle, such as a morpholine ring, a piperidine ring, a pyrrolidine ring, or a piperazine ring (e.g., N-acryloylmorpholine, N-acryloylpiperidine, N-methacryloylpiperidine, and N-acryloylpyrrolidine).

Specific examples of the cyclic ether group-containing monomer include: epoxy group-containing monomers, such as glycidyl (meth)acrylate, 3,4-epoxycyclohexylmethyl (meth)acrylate, 4-hydroxybutyl (meth)acrylate glycidyl ether, methylglycidyl (meth)acrylate, and allyl glycidyl ether; and oxetane group-containing monomers, such as 3-oxetanylmethyl (meth)acrylate, 3-methyl-oxetanylmethyl (meth)acrylate, 3-ethyl-oxetanylmethyl (meth)acrylate, 3-butyl-oxetanylmethyl (meth)acrylate, and 3-hexyl-oxetanylmethyl (meth)acrylate.

Specific examples of the glycol-based acrylic ester monomer include polyethylene glycol (meth)acrylate, polypropylene glycol (meth)acrylate, methoxyethylene glycol (meth)acrylate, and methoxypolypropylene glycol (meth)acrylate.

Specific examples of the styrene-based monomer include styrene and α-methylstyrene.

Specific examples of the amide group-containing monomer include acrylamide, methacrylamide, diethylacrylamide, N-vinylpyrrolidone, N,N-dimethylacrylamide, N,N-dimethylmethacrylamide, N,N-diethylacrylamide, N,N-diethylmethacrylamide, N,N′-methylenebisacrylamide, N,N-dimethylaminopropylacrylamide, N,N-dimethylaminopropylmethacrylamide, diacetone acrylamide, and N,N-hydroxyethylacrylamide.

Specific examples of the amino group-containing monomer include aminoethyl (meth)acrylate, N,N-dimethylaminoethyl (meth)acrylate, and N,N-dimethylaminopropyl (meth)acrylate.

Specific examples of the imide group-containing monomer include cyclohexyl maleimide, isopropyl maleimide, N-cyclohexyl maleimide, and itaconimide.

Specific examples of the silane-based monomer include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

Specific examples of the polyfunctional monomer include: ester compounds of polyhydric alcohols and (meth)acrylic acid, such as (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol penta(meth)acrylate, dipentaerythritol hexa(meth)acrylate, 1,2-ethylene glycol di(meth)acrylate, 1,6-hexanediol di(meth)acrylate, 1,12-dodecanediol di(meth)acrylate, trimethylolpropane tri(meth)acrylate, and tetramethylolmethane tri(meth)acrylate; allyl (meth)acrylate; vinyl (meth)acrylate; divinylbenzene; epoxy acrylate; polyester acrylate; urethane acrylate; butyl di(meth)acrylate; and hexyl di(meth)acrylate.

The polymer component (P) is obtained by the polymerization of the monomer composition (M). The polymer component (P) is typically an acrylic polymer. The polymer components (P) may be used alone or in combination thereof.

Any appropriate production method may be adopted as a method of producing the polymer component (P) to such an extent that the effect of the present invention is not impaired. Examples of such production method include various kinds of radical polymerization including: solution polymerization; active energy ray polymerization, such as UV polymerization; bulk polymerization; and emulsion polymerization. Any appropriate polymerization conditions may be adopted as polymerization conditions to such an extent that the effect of the present invention is not impaired.

Any appropriate polymerization structure may be adopted as the polymerization structure of the polymer component (P) to be obtained to such an extent that the effect of the present invention is not impaired. Examples of such polymerization structure include a random copolymer, a block copolymer, and a graft copolymer.

Any appropriate additive may be adopted as an additive to be used in the radical polymerization, such as a polymerization initiator, a chain transfer agent, or an emulsifying agent, to such an extent that the effect of the present invention is not impaired.

A polymerization solvent that may be used in the solution polymerization or the like is, for example, ethyl acetate or toluene. The polymerization solvents may be used alone or in combination thereof.

The solution polymerization is performed in a stream of an inert gas, such as nitrogen, after the addition of a polymerization initiator typically under the reaction conditions of a temperature of from about 50° C. to about 70° C., and a time period of from about 5 hours to about 30 hours.

Any appropriate thermal polymerization initiator may be adopted as the polymerization initiator that may be used in the solution polymerization or the like to such an extent that the effect of the present invention is not impaired. The polymerization initiators may be used alone or in combination thereof. Examples of such polymerization initiator include: azo-based initiators, such as 2,2′-azobisisobutyronitrile, 2,2′-azobis-2-methylbutyronitrile, dimethyl 2,2′-azobis(2-methylpropionate), 4,4′-azobis-4-cyanovaleric acid, azobisisovaleronitrile, 2,2′-azobis(2-amidinopropane) dihydrochloride, 2,2′-azobis[2-(5-methyl-2-imidazolin-2-yl)propane] dihydrochloride, 2,2′-azobis(2-methylpropionamidine) disulfate, 2,2′-azobis(N,N′-dimethyleneisobutylamidine), and 2,2′-azobis[N-(2-carboxyethyl)-2-methylpropionamidine] hydrate (VA-057, manufactured by Wako Pure Chemical Industries, Ltd.); peroxide-based initiators including persulfates, such as potassium persulfate and ammonium persulfate, di(2-ethylhexyl) peroxydicarbonate, di(4-t-butylcyclohexyl) peroxydicarbonate, di-sec-butyl peroxydicarbonate, t-butyl peroxyneodecanoate, t-hexyl peroxypivalate, t-butyl peroxypivalate, dilauroyl peroxide, di-n-octanoyl peroxide, 1,1,3,3-tetramethylbutyl peroxy-2-ethylhexanoate, di(4-methylbenzoyl) peroxide, dibenzoyl peroxide, t-butyl peroxyisobutyrate, 1,1-di(t-hexylperoxy)cyclohexane, t-butyl hydroperoxide, and hydrogen peroxide; and redox-based initiators each obtained by combining a peroxide and a reducing agent, such as a combination of a persulfate and sodium hydrogen sulfite, and a combination of a peroxide and sodium ascorbate.

The usage amount of the polymerization initiator is preferably 1 part by weight or less, more preferably from 0.005 part by weight to 1 part by weight, still more preferably from 0.01 part by weight to 0.7 part by weight, particularly preferably from 0.02 part by weight to 0.5 part by weight with respect to 100 parts by weight of the total amount of the monomer composition (M) because of, for example, the following reason: the polymerization reaction can be effectively advanced.

Any appropriate chain transfer agent may be adopted as the chain transfer agent to such an extent that the effect of the present invention is not impaired. The chain transfer agents may be used alone or in combination thereof. Examples of such chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol.

The usage amount of the chain transfer agent is preferably 0.1 part by weight or less with respect to 100 parts by weight of the total amount of the monomer composition (M) because of, for example, the following reason: the polymerization reaction can be effectively advanced.

Any appropriate emulsifying agent may be adopted as the emulsifying agent to such an extent that the effect of the present invention is not impaired. The emulsifying agents may be used alone or in combination thereof. Examples of such emulsifying agent include: anionic emulsifying agents, such as sodium lauryl sulfate, ammonium lauryl sulfate, sodium dodecylbenzenesulfonate, an ammonium polyoxyethylene alkyl ether sulfate, and a sodium polyoxyethylene alkyl phenyl ether sulfate; and nonionic emulsifying agents, such as a polyoxyethylene alkyl ether, a polyoxyethylene alkyl phenyl ether, a polyoxyethylene fatty acid ester, and a polyoxyethylene-polyoxypropylene block polymer.

The usage amount of the emulsifying agent is preferably 5 parts by weight or less, more preferably from 0.3 part by weight to 5 parts by weight, still more preferably from 0.4 part by weight to 3 parts by weight, particularly preferably from 0.5 part by weight to 1 part by weight with respect to 100 parts by weight of the total amount of the monomer composition (M) from the viewpoints of polymerization stability and mechanical stability.

When the UV polymerization is performed, a photopolymerization initiator is preferably used.

Any appropriate photopolymerization initiator may be adopted as the photopolymerization initiator to such an extent that the effect of the present invention is not impaired. The photopolymerization initiators may be used alone or in combination thereof. Examples of such photopolymerization initiator include a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzil-based photopolymerization initiator, a benzophenone-based photopolymerization initiator, a ketal-based photopolymerization initiator, a thioxanthone-based photopolymerization initiator, and an acylphosphine oxide-based photopolymerization initiator.

Specific examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one (e.g., a commercial product available under the product name “Irgacure 651” from BASF), and anisole methyl ether.

Specific examples of the acetophenone-based photopolymerization initiator include 1-hydroxycyclohexyl phenyl ketone (e.g., a commercial product available under the product name “Irgacure 184” from BASF), 4-phenoxydichloroacetophenone, 4-t-butyl-dichloroacetophenone, 1-[4-(2-hydroxyethoxy)-phenyl]-2-hydroxy-2-methyl-1-propan-1-one (e.g., a commercial product available under the product name “Irgacure 2959” from BASF), 2-hydroxy-2-methyl-1-phenyl-propan-1-one (e.g., a commercial product available under the product name “DAROCUR 1173” from BASF), and methoxyacetophenone.

Specific examples of the α-ketol-based photopolymerization initiator include 2-methyl-2-hydroxypropiophenone and 1-[4-(2-hydroxyethyl)-phenyl]-2-hydroxy-2-methylpropan-1-one.

A specific example of the aromatic sulfonyl chloride-based photopolymerization initiator is 2-naphthalenesulfonyl chloride.

A specific example of the photoactive oxime-based photopolymerization initiator is 1-phenyl-1,1-propanedione-2-(o-ethoxycarbonyl)-oxime.

A specific example of the benzoin-based photopolymerization initiator is benzoin.

A specific example of the benzil-based photopolymerization initiator is benzil.

Specific examples of the benzophenone-based photopolymerization initiator include benzophenone, benzoylbenzoic acid, 3,3′-dimethyl-4-methoxybenzophenone, polyvinylbenzophenone, and α-hydroxycyclohexyl phenyl ketone.

A specific example of the ketal-based photopolymerization initiator is benzyl dimethyl ketal.

Specific examples of the thioxanthone-based photopolymerization initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, and dodecylthioxanthone.

Specific examples of the acylphosphine-based photopolymerization initiator include bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropan-1-yl)phosphine oxide, bis(2-methoxybenzoyl)(1-methylpropan-1-yl)phosphine oxide, bis(2,6-diethoxybenzoyl)(2-methylpropan-1-yl)phosphine oxide, bis(2,6-diethoxybenzoyl)(1-methylpropan-1-yl)phosphine oxide, bis(2,6-dibutoxybenzoyl)(2-methylpropan-1-yl)phosphine oxide, bis(2,4-dimethoxybenzoyl)(2-methylpropan-1-yl)phosphine oxide, bis(2,4,6-trimethylbenzoyl)(2,4-dipentoxyphenyl)phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoylbenzylbutylphosphine oxide, 2,6-dimethoxybenzoylbenzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyldiphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide.

The usage amount of the photopolymerization initiator is preferably 5 parts by weight or less, more preferably from 0.01 part by weight to 5 parts by weight, still more preferably from 0.05 part by weight to 3 parts by weight, particularly preferably from 0.05 part by weight to 1.5 parts by weight, most preferably from 0.1 part by weight to 1 part by weight with respect to 100 parts by weight of the total amount of the monomer composition (M) from the viewpoint of, for example, the expression of satisfactory polymerizability.

When the UV polymerization is performed, a polyfunctional (meth)acrylate is preferably used.

Any appropriate polyfunctional (meth)acrylate may be adopted as the polyfunctional (meth)acrylate to such an extent that the effect of the present invention is not impaired. The polyfunctional (meth)acrylates may be used alone or in combination thereof. Specific examples of such polyfunctional (meth)acrylate include: ester compounds of polyhydric alcohols and (meth)acrylic acid, such as (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol penta(meth)acrylate, dipentaerythritol hexa(meth)acrylate, 1,2-ethylene glycol di(meth)acrylate, 1,6-hexanediol di(meth)acrylate, 1,12-dodecanediol di(meth)acrylate, trimethylolpropane tri(meth)acrylate, and tetramethylolmethane tri(meth)acrylate; allyl (meth)acrylate; vinyl (meth)acrylate; divinylbenzene; epoxy acrylate; polyester acrylate; urethane acrylate; butyl di(meth)acrylate; and hexyl di(meth)acrylate.

The usage amount of the polyfunctional (meth)acrylate is preferably 5 parts by weight or less, more preferably from 0.01 part by weight to 5 parts by weight, still more preferably from 0.05 part by weight to 3 parts by weight, particularly preferably from 0.05 part by weight to 1.5 parts by weight, most preferably from 0.1 part by weight to 1 part by weight with respect to 100 parts by weight of the total amount of the monomer composition (M) from the viewpoint of, for example, the expression of satisfactory cross-linkability.

Any appropriate UV polymerization method may be adopted as a method for the UV polymerization to such an extent that the effect of the present invention is not impaired. Such UV polymerization method is, for example, as follows: the monomer composition (M) is blended with the photopolymerization initiator, and as required, the polyfunctional (meth)acrylate, and the resultant is irradiated with UV light.

The weight-average molecular weight of the polymer component (P) is preferably from 100,000 to 3,000,000, more preferably from 300,000 to 2,000,000, still more preferably from 500,000 to 1,500,000, particularly preferably from 500,000 to 1,000,000 because the effect of the present invention can be further expressed. The weight-average molecular weight is a value measured by gel permeation chromatography (GPC) and calculated in terms of polystyrene. It may be difficult to measure the weight-average molecular weight of the polymer component (P) obtained by active energy ray polymerization.

The pressure-sensitive adhesive composition may contain a tackifying resin. The tackifying resins may be used alone or in combination thereof.

Any appropriate tackifying resin may be adopted as the tackifying resin to such an extent that the effect of the present invention is not impaired. Examples of such tackifying resin include a phenol-based tackifying resin, a terpene-based tackifying resin, a modified terpene-based tackifying resin, a rosin-based tackifying resin, a hydrocarbon-based tackifying resin, an epoxy-based tackifying resin, a polyamide-based tackifying resin, an elastomer-based tackifying resin, and a ketone-based tackifying resin.

Examples of the phenol-based tackifying resin include a terpene-phenol resin, a hydrogenated terpene-phenol resin, an alkyl phenol resin, and a rosin-phenol resin. The terpene-phenol resin refers to a polymer including a terpene residue and a phenol residue, and is a concept including both of a copolymer of a terpene and a phenol compound (terpene-phenol copolymer resin) and a phenol-modified product of a homopolymer or a copolymer of a terpene (phenol-modified terpene resin). Examples of the terpene forming such terpene-phenol resin include monoterpenes, such as α-pinene, β-pinene, and limonene (including a d-form, an l-form, and a d/l-form (dipentene)). The hydrogenated terpene-phenol resin refers to a hydrogenated terpene-phenol resin having a structure obtained by hydrogenation of such terpene-phenol resin, and is sometimes referred to as hydrogenated terpene-phenol resin. The alkyl phenol resin is a resin (oil-based phenol resin) obtained from an alkyl phenol and formaldehyde. Examples of the alkyl phenol resin include novolac-type and resol-type resins. Examples of the rosin-phenol resin include phenol-modified products of rosins or various rosin derivatives (including rosin esters, unsaturated fatty acid-modified rosins, and unsaturated fatty acid-modified rosin esters). The rosin-phenol resin is, for example, a rosin-phenol resin obtained by a method involving adding phenol to the rosins or the various rosin derivatives with an acid catalyst, and thermally polymerizing the resultant.

Examples of the terpene-based tackifying resin include polymers of terpenes, such as α-pinene, β-pinene, d-limonene, l-limonene, and dipentene (typically monoterpenes). A homopolymer of one kind of terpene is, for example, an α-pinene polymer, a β-pinene polymer, or a dipentene polymer.

Examples of the modified terpene resin include a styrene-modified terpene resin and a hydrogenated terpene resin.

The concept of the rosin-based tackifying resin includes both of the rosins and rosin derivative resins. Examples of the rosins include: unmodified rosins (raw rosins), such as gum rosin, wood rosin, and tall oil rosin; and modified rosins obtained by modifying these unmodified rosins through hydrogenation, disproportionation, polymerization, or the like (e.g., a hydrogenated rosin, a disproportionated rosin, a polymerized rosin, and any other chemically modified rosin).

Examples of the rosin derivative resins include: rosin esters, such as unmodified rosin esters that are esters of the unmodified rosins and alcohols, and modified rosin esters that are esters of the modified rosins and alcohols; unsaturated fatty acid-modified rosins obtained by modifying the rosins with unsaturated fatty acids; unsaturated fatty acid-modified rosin esters obtained by modifying the rosin esters with unsaturated fatty acids; rosin alcohols obtained by subjecting carboxy groups of the rosins or the rosin derivative resins (e.g., the rosin esters, the unsaturated fatty acid-modified rosins, and the unsaturated fatty acid-modified rosin esters) to reduction treatments; and metal salts thereof. Examples of the rosin esters include methyl esters, triethylene glycol esters, glycerin esters, and pentaerythritol esters of unmodified rosins or modified rosins (e.g., a hydrogenated rosin, a disproportionated rosin, and a polymerized rosin).

Examples of the hydrocarbon-based tackifying resin include an aliphatic hydrocarbon resin, an aromatic hydrocarbon resin, an aliphatic cyclic hydrocarbon resin, an aliphatic-aromatic petroleum resin (e.g., a styrene-olefin-based copolymer), an aliphatic-alicyclic petroleum resin, a hydrogenated hydrocarbon resin, a coumarone-based resin, and a coumarone-indene-based resin.

The content of the tackifying resin in the pressure-sensitive adhesive composition is preferably from 1 part by weight to 50 parts by weight, more preferably from 5 parts by weight to 40 parts by weight, still more preferably from 10 parts by weight to 30 parts by weight, particularly preferably from 15 parts by weight to 25 parts by weight with respect to 100 parts by weight of the total amount of the monomer composition (M). When the content of the tackifying resin in the pressure-sensitive adhesive composition is adjusted within the ranges, there can be provided a laminate including a laminated structure of a pressure-sensitive adhesive sheet, a reinforcing agent layer, and an adherend, the laminate being capable of expressing both of a higher adhesive strength and higher impact resistance.

The pressure-sensitive adhesive composition may contain a cross-linking agent. The cross-linking agents may be used alone or in combination thereof. When the pressure-sensitive adhesive composition contains the cross-linking agent, there can be provided a laminate including a laminated structure of a pressure-sensitive adhesive sheet, a reinforcing agent layer, and an adherend, the laminate being capable of expressing both of a higher adhesive strength and higher impact resistance.

Any appropriate cross-linking agent may be adopted as the cross-linking agent to such an extent that the effect of the present invention is not impaired. Examples of such cross-linking agent include an isocyanate-based cross-linking agent and a non-isocyanate-based cross-linking agent.

Any appropriate isocyanate-based cross-linking agent may be adopted as the isocyanate-based cross-linking agent to such an extent that the effect of the present invention is not impaired. Examples of such isocyanate-based cross-linking agent include an aromatic diisocyanate, an aliphatic diisocyanate, and an alicyclic diisocyanate, and dimers and trimers of those diisocyanates. Specific examples thereof include tolylene diisocyanate, diphenylmethane diisocyanate, hexamethylene diisocyanate, xylylene diisocyanate, hydrogenated xylylene diisocyanate, isophorone diisocyanate, hydrogenated diphenylmethane diisocyanate, 1,5-naphthylene diisocyanate, 1,3-phenylene diisocyanate, 1,4-phenylene diisocyanate, butane-1,4-diisocyanate, 2,2,4-trimethylhexamethylene diisocyanate, 2,4,4-trimethylhexamethylene diisocyanate, cyclohexane-1,4-diisocyanate, dicyclohexylmethane-4,4-diisocyanate, 1,3-bis(isocyanatomethyl)cyclohexane, methylcyclohexane diisocyanate, and m-tetramethylxylylene diisocyanate, and dimers and trimers thereof, and polyphenylmethane polyisocyanate. In addition, the trimer may be of, for example, an isocyanurate type, a biuret type, or an allophanate type.

A commercial product may be used as the isocyanate-based cross-linking agent. Examples of a commercial product of the polyisocyanate include a product available under the product name “TAKENATE 600” from Mitsui Chemicals, Inc., a product available under the product name “DURANATE TPA100” from Asahi Kasei Chemicals Corporation, and products available under the product names “CORONATE L”, “CORONATE HL”, “CORONATE HK”, “CORONATE HX”, and “CORONATE 2096” from Nippon Polyurethane Industry Co., Ltd.

Examples of the non-isocyanate-based cross-linking agent include an epoxy-based cross-linking agent, an oxazoline-based cross-linking agent, an aziridine-based cross-linking agent, a melamine-based cross-linking agent, a carbodiimide-based cross-linking agent, a hydrazine-based cross-linking agent, an amine-based cross-linking agent, a peroxide-based cross-linking agent, a metal chelate-based cross-linking agent, a metal alkoxide-based cross-linking agent, a metal salt-based cross-linking agent, and a silane coupling agent.

In at least one exemplary embodiment of the present invention, the epoxy-based cross-linking agent may be adopted as the non-isocyanate-based cross-linking agent. The epoxy-based cross-linking agent is preferably, for example, a compound having 2 or more epoxy groups in a molecule thereof, and is more preferably, for example, an epoxy-based cross-linking agent having 3 to 5 epoxy groups in a molecule thereof.

Specific examples of the epoxy-based cross-linking agent include N,N,N′,N′-tetraglycidyl-m-xylenediamine, 1,3-bis(N,N-diglycidylaminomethyl)cyclohexane, 1,6-hexanediol diglycidyl ether, polyethylene glycol diglycidyl ether, and polyglycerol polyglycidyl ether. Examples of a commercial product of the epoxy-based cross-linking agent include products available under the product names “TETRAD-C” and “TETRAD-X” from Mitsubishi Gas Chemical Company, a product available under the product name “EPICLON CR-5L” from DIC Corporation, a product available under the product name “DENACOL EX-512” from Nagase ChemteX Corporation, and a product available under the product name “TEPIC-G” from Nissan Chemical Industries, Ltd.

The content of the cross-linking agent in the pressure-sensitive adhesive composition is preferably from 0.01 part by weight to 10 parts by weight, more preferably from 0.1 part by weight to 8 parts by weight, still more preferably from 0.5 part by weight to 7 parts by weight, particularly preferably from 1.5 parts by weight to 5 parts by weight with respect to 100 parts by weight of the total amount of the monomer composition (M). When the content of the cross-linking agent in the pressure-sensitive adhesive composition is adjusted within the ranges, there can be provided a laminate including a laminated structure of a pressure-sensitive adhesive sheet, a reinforcing agent layer, and an adherend, the laminate being capable of expressing both of a higher adhesive strength and higher impact resistance.

In the pressure-sensitive adhesive composition, the isocyanate-based cross-linking agent and the non-isocyanate-based cross-linking agent (e.g., the epoxy-based cross-linking agent) may be used in combination. In this case, the ratio of the content of the non-isocyanate-based cross-linking agent in the pressure-sensitive adhesive composition to the content of the isocyanate-based cross-linking agent in the pressure-sensitive adhesive composition is preferably 1/50 or less, more preferably 1/75 or less, still more preferably 1/100 or less, particularly preferably 1/150 or less because there can be provided a laminate including a laminated structure of a pressure-sensitive adhesive sheet, a reinforcing agent layer, and an adherend, the laminate being capable of expressing both of a higher adhesive strength and higher impact resistance. In addition, the ratio of the content of the non-isocyanate-based cross-linking agent in the pressure-sensitive adhesive composition to the content of the isocyanate-based cross-linking agent in the pressure-sensitive adhesive composition is preferably 1/1,000 or more, more preferably 1/500 or more because there can be provided a laminate including a laminated structure of a pressure-sensitive adhesive sheet, a reinforcing agent layer, and an adherend, the laminate being capable of expressing both of a higher adhesive strength and higher impact resistance.

The pressure-sensitive adhesive composition may contain any appropriate other component to such an extent that the effect of the present invention is not impaired. Examples of such other component include a resin component except the polymer component (P), an inorganic filler, an organic filler, metal powder, a colorant, a foil product, a softening agent, an age resistor, a conductive agent, a UV absorber, an antioxidant, a light stabilizer, a surface lubricant, a leveling agent, a corrosion inhibitor, a rust inhibitor, a heat stabilizer, a polymerization inhibitor, a lubricant, a solvent, and a catalyst.

The pressure-sensitive adhesive composition may contain any appropriate colorant to such an extent that the effect of the present invention is not impaired from the viewpoint of, for example, the adjustment of light transparency (light-shielding property). A hitherto known pigment or dye may be used as such colorant. Examples of the pigment include: inorganic pigments, such as carbon black, zinc carbonate, zinc oxide, zinc sulfide, talc, kaolin, calcium carbonate, titanium oxide, silica, lithium fluoride, calcium fluoride, barium sulfate, alumina, zirconia, an iron oxide-based pigment, an iron hydroxide-based pigment, a chromium oxide-based pigment, a spinel-type calcined pigment, a chromic acid-based pigment, a chromium vermilion-based pigment, an iron blue-based pigment, an aluminum powder-based pigment, a bronze powder-based pigment, a silver powder-based pigment, and calcium phosphate; and organic pigments, such as a phthalocyanine-based pigment, an azo-based pigment, a condensed azo-based pigment, an azo lake-based pigment, an anthraquinone-based pigment, a perylene/perinone-based pigment, an indigo-based pigment, a thioindigo-based pigment, an isoindolinone-based pigment, an azomethine-based pigment, a dioxazine-based pigment, a quinacridone-based pigment, an aniline black-based pigment, and a triphenylmethane-based pigment. Examples of the dye include an azo-based dye, anthraquinone, quinophthalone, a styryl-based dye, diphenylmethane, triphenylmethane, oxazine, triazine, xanthane, azomethine, acridine, and diazine. The colorants may be used alone or in combination thereof.

A black colorant is specifically, for example, carbon black, graphite, copper oxide, manganese dioxide, aniline black, perylene black, titanium black, cyanine black, activated carbon, ferrite (e.g., non-magnetic ferrite or magnetic ferrite), magnetite, chromium oxide, iron oxide, molybdenum disulfide, a chromium complex, or an anthraquinone-based colorant.

The content of the colorant in the pressure-sensitive adhesive composition is preferably less than 30 wt %, more preferably less than 20 wt %, still more preferably less than 13 wt %, particularly preferably less than 10 wt %, most preferably less than 8 wt %.

<1-1-2. Base Material Layer>

The pressure-sensitive adhesive sheet may include the base material layer.

The thickness of the base material layer is preferably from 1 μm to 100 μm because the effect of the present invention can be further expressed, and the thickness is more preferably from 1 μm to 70 μm, still more preferably from 1 μm to 50 μm, particularly preferably from 5 μm to 30 μm, most preferably from 10 μm to 25 μm.

The base material layer preferably contains, as a resin component, at least one kind selected from the group consisting of polyolefin, thermoplastic polyurethane, and a styrene-based polymer in order that the effect of the present invention may be sufficiently expressed. The number of kinds of the resins in the base material layer may be only one, or two or more.

The content of the resin component in the base material layer is preferably from 50 wt % to 100 wt % because the effect of the present invention can be more sufficiently expressed, and the content is more preferably from 70 wt % to 100 wt %, still more preferably from 90 wt % to 100 wt %, still more preferably from 95 wt % to 100 wt %, particularly preferably from 98 wt % to 100 wt %, most preferably substantially 100 wt %.

Herein, a case described as “substantially 100 wt %” means that a trace amount of an impurity or the like may be incorporated to such an extent that the effect of the present invention is not impaired, and such case may be typically referred to as “100 wt %”.

Any appropriate polyolefin may be adopted as the polyolefin to such an extent that the effect of the present invention is not impaired. Such polyolefin is preferably at least one kind selected from the group consisting of polyethylene, polypropylene, and polybutene-1 because the effect of the present invention can be more sufficiently expressed, and the polyolefin is more preferably at least one kind selected from the group consisting of polyethylene and polypropylene.

The polyethylene is, for example, at least one kind selected from the group consisting of low-density polyethylene (LDPE), linear low-density polyethylene (LLDPE), ultralow-density polyethylene, medium-density polyethylene (MDPE), high-density polyethylene (HDPE), and ultrahigh-density polyethylene.

The polyethylene may be metallocene-catalyzed polyethylene obtained by using a metallocene catalyst. A commercial product may be adopted as the polyethylene.

The polypropylene is, for example, at least one kind selected from the group consisting of random polypropylene, block polypropylene, and homopolypropylene.

The polypropylene may be metallocene-catalyzed polypropylene obtained by using a metallocene catalyst. A commercial product may be adopted as the polypropylene.

The polybutene-1 may be metallocene-catalyzed polybutene-1 obtained by using a metallocene catalyst. A commercial product may be adopted as the polybutene-1.

Any appropriate thermoplastic polyurethane may be adopted as the thermoplastic polyurethane to such an extent that the effect of the present invention is not impaired. An example of such thermoplastic polyurethane, which is generally called TPU, is a block copolymer containing a hard segment and a soft segment. A preferred example of such thermoplastic polyurethane is at least one kind selected from the group consisting of polyester-based TPU, polyether-based TPU, and polycarbonate-based TPU because the effect of the present invention can be more sufficiently expressed.

A commercial product may be adopted as the thermoplastic polyurethane.

Any appropriate styrene-based polymer may be adopted as the styrene-based polymer to such an extent that the effect of the present invention is not impaired. Such styrene-based polymer is preferably, for example, a polymer containing a styrene-based thermoplastic elastomer because the effect of the present invention can be more sufficiently expressed.

Examples of the styrene-based thermoplastic elastomer include: AB-type block polymers, such as a hydrogenated styrene-butadiene rubber (HSBR), a styrene-based block copolymer or a hydrogenated product thereof, a styrene-butadiene copolymer (SB), a styrene-isoprene copolymer (SI), a copolymer of a styrene-ethylene-butylene copolymer (SEB), and a copolymer of a styrene-ethylene-propylene copolymer (SEP); styrene-based random copolymers, such as a styrene-butadiene rubber (SBR); A-B-C-type styrene-olefin crystal-based block polymers, such as a copolymer of a styrene-ethylene-butylene copolymer and an olefin crystal (SEBC); and hydrogenated products thereof. The styrene-based thermoplastic elastomer is preferably, for example, at least one kind selected from the group consisting of a hydrogenated styrene-butadiene rubber (HSBR), and a styrene-based block copolymer or a hydrogenated product thereof because the effect of the present invention can be more sufficiently expressed.

Examples of the hydrogenated styrene-butadiene rubber (HSBR) include DYNARON 1320P, 1321P, and 2324P manufactured by JSR Corporation.

Examples of the styrene-based block copolymer include: styrene-based ABA-type block copolymers (triblock copolymers), such as a styrene-butadiene-styrene copolymer (SBS) and a styrene-isoprene-styrene copolymer (SIS); styrene-based ABAB-type block copolymers (tetrablock copolymers), such as a styrene-butadiene-styrene-butadiene copolymer (SBSB) and a styrene-isoprene-styrene-isoprene copolymer (SISI); styrene-based ABABA-type block copolymers (pentablock copolymers), such as a styrene-butadiene-styrene-butadiene-styrene copolymer (SBSBS) and a styrene-isoprene-styrene-isoprene-styrene copolymer (SISIS); and styrene-based block copolymers each having a larger number of AB repeating units.

Examples of the hydrogenated product of the styrene-based block copolymer include a styrene-ethylene-butylene copolymer-styrene copolymer (SEBS), a styrene-ethylene-propylene copolymer-styrene copolymer (SEPS), and a copolymer of a styrene-ethylene-butylene copolymer and a styrene-ethylene-butylene copolymer (SEBSEB).

Examples of the styrene-ethylene-butylene copolymer-styrene copolymer (SEBS) include DYNARON 8601P and 9901P manufactured by JSR Corporation.

A styrene content in the styrene-based thermoplastic elastomer (styrene block content in the case of the styrene-based block copolymer) is preferably from 1 wt % to 40 wt % because the effect of the present invention can be more sufficiently expressed, and the content is more preferably from 5 wt % to 40 wt %, still more preferably from 7 wt % to 30 wt %, still more preferably from 9 wt % to 20 wt %, particularly preferably from 9 wt % to 15 wt %, most preferably from 9 wt % to 13 wt %.

A hydrogenated product of a styrene-based block copolymer (e.g., a SEBS, a SEBSEB, or a SEBSEBS) having a repeating structure (e.g., an ABA type, an ABAB type, or an ABABA type) corresponding to a triblock copolymer or more formed of styrene (A) and butadiene (B) is suitable as the styrene-based thermoplastic elastomer because the effect of the present invention can be more sufficiently expressed.

When the styrene-based thermoplastic elastomer is a hydrogenated product of a styrene-based block copolymer (e.g., a SEBS, a SEBSEB, or a SEBSEBS) having a repeating structure (e.g., an ABA type, an ABAB type, or an ABABA type) corresponding to a triblock copolymer or more formed of styrene (A) and butadiene (B), the ratio of a butylene structure in an ethylene-butylene copolymer block is preferably 60 wt % or more because the effect of the present invention can be more sufficiently expressed, and the ratio is more preferably 70 wt % or more, still more preferably 75 wt % or more. The ratio of the butylene structure in the ethylene-butylene copolymer block is preferably 90 wt % or less.

The styrene-based polymer may contain any appropriate other polymer except the styrene-based polymer to such an extent that the effect of the present invention is not impaired. Examples of such other polymer include an ethylene/vinyl acetate copolymer, an ethylene/acrylic acid copolymer, an ethylene/methacrylic acid copolymer, an ethylene/acrylic acid ester copolymer, an ethylene/methacrylic acid ester copolymer, an ethylene/butene-1 copolymer, an ethylene/propylene/butene-1 copolymer, a copolymer of ethylene and an α-olefin having 5 to 12 carbon atoms, and an ethylene/non-conjugated diene copolymer. Of those, an ethylene/vinyl acetate copolymer is preferred.

A preferred embodiment of the styrene-based polymer is, for example, a blend product of a hydrogenated product of a styrene-based block copolymer (e.g., a SEBS, a SEBSEB, or a SEBSEBS) and an ethylene/vinyl acetate copolymer because the effect of the present invention can be more sufficiently expressed, and the embodiment is preferably a blend product of a SEBS and an ethylene/vinyl acetate copolymer.

The base material layer may be formed of one layer (single layer), or two or more layers (a plurality of layers).

The base material layer may contain any appropriate additive as required. Examples of the additive that may be incorporated into the base material layer include a release agent, a UV absorber, a heat stabilizer, a filler, a lubricant, a colorant (e.g., a dye), an antioxidant, an anti-build up agent, an anti-blocking agent, a foaming agent, and polyethyleneimine. Those additives may be used alone or in combination thereof. The content of the additive in the base material layer is preferably 10 wt % or less, more preferably 7 wt % or less, still more preferably 5 wt % or less, particularly preferably 2 wt % or less, most preferably 1 wt % or less.

<1-1-3. Production of Pressure-Sensitive Adhesive Sheet>

The pressure-sensitive adhesive sheet may be produced by any appropriate method to such an extent that the effect of the present invention is not impaired. Examples of such method include: a method (direct method) involving applying the pressure-sensitive adhesive composition onto any appropriate base material (e.g., the base material layer or the release liner), and drying the composition as required, to form the pressure-sensitive adhesive layer on the base material (e.g., the base material layer or the release liner); a method (transfer method) involving applying the pressure-sensitive adhesive composition to a surface having releasability (e.g., the release surface of the release liner), and drying the composition as required, to form the pressure-sensitive adhesive layer on the release surface, and transferring the pressure-sensitive adhesive layer onto any appropriate base material (e.g., the base material layer); and a combination of these methods. For example, a laminator may be used in the bonding of various kinds of layers. In addition, after the bonding, the resultant may be aged under any appropriate temperature for any appropriate time as required.

<<1-2. Reinforcing Agent Layer>>

The reinforcing agent layers may be used alone or in combination thereof.

The thickness of the reinforcing agent layer is preferably from 0.05 μm to 10.0 μm because the effect of the present invention can be further expressed, and the thickness is more preferably from 0.05 μm to 7.00 μm, still more preferably from 0.10 μm to 5.00 μm, particularly preferably from 0.19 μm to 4.00 μm, most preferably from 0.19 μm to 1.00 μm.

The reinforcing agent layer is preferably formed from a reinforcing agent. Any appropriate method may be adopted as a method of forming the reinforcing agent layer to such an extent that the effect of the present invention is not impaired. Such method is, for example, a method involving applying the reinforcing agent in a liquid state (in the case where the reinforcing agent is in a liquid state, the reinforcing agent itself, and in any other case, for example, a solution of the reinforcing agent or a dispersion liquid of the reinforcing agent) onto any appropriate base material (typically the adherend), and drying the reinforcing agent as required, to form the reinforcing agent layer on the base material (typically the adherend). The solution of the reinforcing agent, the dispersion liquid of the reinforcing agent, or the like is preferably a solution in an aqueous medium (e.g., water or an alcohol) or a dispersion liquid in an aqueous medium (e.g., water or an alcohol) in an environmental aspect, and is more preferably an aqueous solution or a water dispersion liquid.

The reinforcing agent preferably contains an aqueous urethane resin bonded by an isocyanate-based cross-linking agent, the resin having at least one kind selected from the group consisting of an ester skeleton, an ether skeleton, and a carbonate skeleton. When the reinforcing agent contains such aqueous urethane resin, there can be provided a laminate including a laminated structure of a pressure-sensitive adhesive sheet, a reinforcing agent layer, and an adherend, the laminate being capable of expressing both of a higher adhesive strength and higher impact resistance.

The content of the aqueous urethane resin in the reinforcing agent is preferably from 50 wt % to 100 wt %, more preferably from 70 wt % to 100 wt %, still more preferably from 90 wt % to 100 wt %, still more preferably from 95 wt % to 100 wt %, particularly preferably from 98 wt % to 100 wt %, most preferably substantially 100 wt % in terms of solid content.

The elongation of the aqueous urethane resin is preferably from 300% to 1,500%, more preferably from 300% to 1,200%, still more preferably from 300% to 1,000%, particularly preferably from 300% to 900%, most preferably from 300% to 800%. When the elongation of the aqueous urethane resin falls within the ranges, there can be provided a laminate including a laminated structure of a pressure-sensitive adhesive sheet, a reinforcing agent layer, and an adherend, the laminate being capable of expressing both of a higher adhesive strength and higher impact resistance.

The aqueous urethane resin is preferably a nonreactive aqueous urethane resin. When the aqueous urethane resin is the nonreactive aqueous urethane resin, there can be provided a laminate including a laminated structure of a pressure-sensitive adhesive sheet, a reinforcing agent layer, and an adherend, the laminate being capable of expressing both of a higher adhesive strength and higher impact resistance.

The nonreactive aqueous urethane resin is preferably a self-emulsifying aqueous urethane resin. When the nonreactive aqueous urethane resin is the self-emulsifying aqueous urethane resin, there can be provided a laminate including a laminated structure of a pressure-sensitive adhesive sheet, a reinforcing agent layer, and an adherend, the laminate being capable of expressing both of a higher adhesive strength and higher impact resistance.

<<1-3. Adherend>>

Any appropriate adherend may be selected as the adherend to such an extent that the effect of the present invention is not impaired. Such adherend is preferably an electronic device member because the effect of the present invention can be further exploited. That is, when the laminate according to at least one embodiment of the present invention is a laminate including the laminated structure of the pressure-sensitive adhesive sheet, the reinforcing agent layer, and the electronic device member serving as the adherend, the laminate can express both of a high adhesive strength and high impact resistance, which are important for an article including the electronic device member (typically a mobile device), in a balanced manner.

A material for the adhesion site of such adherend is specifically, for example, at least one kind selected from the group consisting of SUS, polycarbonate, aluminum, a polyolefin-based resin, a styrene-based resin, a polyester-based resin, an acrylic resin, a polyimide-based resin, and a glass fiber.

<<<<2. Method of Producing Laminate>>>>

The laminate according to at least one embodiment of the present invention may be produced by any appropriate method to such an extent that the effect of the present invention is not impaired.

The method of producing the laminate according to at least one embodiment of the present invention preferably includes a step (I) of applying, to the surface of the adherend, an aqueous paint containing the reinforcing agent and an aqueous medium to form the reinforcing agent layer, and a step (II) of bonding the pressure-sensitive adhesive sheet to the surface of the reinforcing agent layer thus formed. The method of producing the laminate according to at least one embodiment of the present invention may include any appropriate other step to such an extent that the effect of the present invention is not impaired as long as the method includes the step (I) and the step (II).

<<2-1. Step (I)>>

In the step (I), the aqueous paint containing the reinforcing agent and the aqueous medium is preferably applied to the surface of the adherend to form the reinforcing agent layer. Any appropriate application method may be adopted as a method for the application to such an extent that the effect of the present invention is not impaired. Such application method is, for example, roll coating, kiss roll coating, gravure coating, reverse coating, roll brushing, spray coating, dip roll coating, bar coating, knife coating, air knife coating, curtain coating, lip coating, or extrusion coating using a die coater.

In the step (I), heating or aging may be performed as required.

The aqueous paint preferably contains the reinforcing agent and the aqueous medium. The aqueous paint may contain any appropriate other component to such an extent that the effect of the present invention is not impaired.

The total content of the reinforcing agent and the aqueous medium in the aqueous paint is preferably from 50 parts by weight to 100 parts by weight, more preferably from 80 parts by weight to 100 parts by weight, still more preferably from 90 parts by weight to 100 parts by weight, particularly preferably from 95 parts by weight to 100 parts by weight, most preferably substantially 100 parts by weight with respect to 100 parts by weight of the aqueous paint.

Examples of the aqueous medium include water and an alcohol. Examples of the alcohol include methanol, ethanol, n-propyl alcohol, isopropyl alcohol, n-butyl alcohol, isobutyl alcohol, and t-butyl alcohol.

The content of the reinforcing agent in 100 parts by weight of the aqueous paint is preferably from 0.1 part by weight to 50 parts by weight, more preferably from 0.5 part by weight to 40 parts by weight, still more preferably from 1.0 part by weight to 30 parts by weight, particularly preferably from 1.5 parts by weight to 20 parts by weight, most preferably from 1.5 parts by weight to 15 parts by weight. When the content of the reinforcing agent in 100 parts by weight of the aqueous paint is adjusted within the ranges, there can be produced a laminate including a laminated structure of a pressure-sensitive adhesive sheet, a reinforcing agent layer, and an adherend, the laminate being capable of expressing higher impact resistance even when the thickness of the reinforcing agent layer is small, and being capable of expressing a higher adhesive strength.

The method of forming the reinforcing agent layer preferably includes applying the aqueous paint onto any appropriate base material (typically the adherend), and drying the paint as required, to form the reinforcing agent layer on the base material (typically the adherend).

<<2-2. Step (II)>>

In the step (II), the pressure-sensitive adhesive sheet is preferably bonded to the surface of the reinforcing agent layer.

Any appropriate bonding method may be adopted as a method of bonding the pressure-sensitive adhesive sheet to the surface of the reinforcing agent layer to such an extent that the effect of the present invention is not impaired. Examples of such bonding method include a flat pressing machine configured to horizontally apply a pressure, a hand roller, a room-temperature laminator, a warming laminator, a vacuum pressure-bonding machine, and an autoclave.

### EXAMPLES

Now, the present invention is specifically described by way of Examples. However, the present invention is by no means limited to Examples. Test and evaluation methods in Examples and the like are as described below. The term “part(s)” in the following description means “part(s) by weight” unless otherwise specified, and the term “%” in the following description means “wt %” unless otherwise specified.

<Weight-average Molecular Weight>

A weight-average molecular weight was determined from a value in terms of standard polystyrene obtained by gel permeation chromatography (GPC). An apparatus available under the model name “HLC-8320 GPC” (column: TSKgel GMH-H(S), manufactured by Tosoh Corporation) was used as a GPC apparatus.

<Measurement of Thickness of Reinforcing Agent Layer>

The thickness of a reinforcing agent layer was measured with a laser microscope (manufactured by Keyence Corporation, VK-X250).

<Adhesive Strength Measurement>

(1. Production of Laminated Structural Body of Reinforcing Agent Layer and SUS Plate to be Used in Adhesive Strength Measurement)

A reinforcing agent solution to be used in the production of a laminate to be obtained in each of Examples and Comparative Examples was uniformly applied onto a stainless-steel plate (SUS304BA plate) (manufactured by Nippon Kinzoku Co., Ltd.), which had been washed with toluene, with an applicator (manufactured by AS ONE Corporation, 1-3777-01) so that the thickness of a reinforcing agent layer in the laminate to be obtained in each of Examples and Comparative Examples was obtained. After that, the resultant was dried in an oven at 70° C. for 5 minutes to produce a laminated structural body (A) of the reinforcing agent layer and the SUS plate.

(2. Production of Laminated Structural Body of Reinforcing Agent Layer and Polycarbonate Plate to be Used in Adhesive Strength Measurement)

The reinforcing agent solution to be used in the production of the laminate to be obtained in each of Examples and Comparative Examples was uniformly applied onto a polycarbonate plate (manufactured by Mitsubishi Chemical Corporation), which had been washed with isopropyl alcohol, with an applicator (manufactured by AS ONE Corporation, 1-3777-01) so that the thickness of the reinforcing agent layer in the laminate to be obtained in each of Examples and Comparative Examples was obtained. After that, the resultant was dried in an oven at 70° C. for 5 minutes to produce a laminated structural body (B) of the reinforcing agent layer and the polycarbonate plate.

(3. Production of Laminated Structural Body of Reinforcing Agent Layer and Aluminum Plate to be used in Adhesive Strength Measurement)

The reinforcing agent solution to be used in the production of the laminate to be obtained in each of Examples and Comparative Examples was uniformly applied onto an aluminum plate (manufactured by Nippon Testpanel Co., Ltd.) with an applicator (manufactured by AS ONE Corporation, 1-3777-01) so that the thickness of the reinforcing agent layer in the laminate to be obtained in each of Examples and Comparative Examples was obtained. After that, the resultant was dried in an oven at 70° C. for 5 minutes to produce a laminated structural body (C) of the reinforcing agent layer and the aluminum plate.

(Adhesive Strength)

A PET film (without release treatment) having a thickness of 50 μm was bonded to one pressure-sensitive adhesive layer surface of a pressure-sensitive adhesive sheet to be used in the laminate to be obtained in each of Examples and Comparative Examples to back the surface. The backed pressure-sensitive adhesive sheet was cut into a width of 20 mm to produce a test piece.

By one pass back and forth with a 2 kg roller, the pressure-sensitive adhesive layer surface of the resultant test piece was pressure-bonded to each of the above-mentioned various laminated structural bodies (A), (B), and (C). The resultant was placed under a measurement environment at 23° C. and 50% RH for 30 minutes, and an adhesive strength (N/20 mm) when the pressure-sensitive adhesive sheet was peeled off with a tensile tester (manufactured by Shimadzu Corporation, “PRECISION UNIVERSAL TESTER AUTOGRAPH AG-IS 50N”) in conformity with JIS Z 0237:2000 at a tensile rate of 300 mm/min and a peel angle of 180° was measured.

<Impact Resistance Measurement>

(Production of Laminated Structural Body of Reinforcing Agent Layer and SUS Plate to be Used in Impact Resistance Measurement)

A square stainless-steel plate (SUS304BA) (X1) measuring 2 mm thick by 50 mm long by 50 mm wide, which was perforated with a hole measuring 20 mm long by 20 mm wide at its central portion, and a square stainless-steel plate (SUS304BA) (Y1) measuring 3 mm thick by 25 mm long by 25 mm wide were prepared as adherends. First, the respective adherends were washed with toluene. After that, the reinforcing agent solution to be used in the production of the laminate to be obtained in each of Examples and Comparative Examples was uniformly applied onto each of the adherends with an applicator (manufactured by AS ONE Corporation, 1-3777-01) so that the thickness of the reinforcing agent layer in the laminate to be obtained in each of Examples and Comparative Examples was obtained. After that, the resultant was dried in an oven at 70° C. for 5 minutes to provide a laminated structural body (X) of the reinforcing agent layer and the SUS plate (X1), or a laminated structural body (Y) of the reinforcing agent layer and the SUS plate (Y1).

(Impact Resistance)

A pressure-sensitive adhesive sheet sandwiched between release liners was punched into a square frame shape having a width of 2 mm, an outside longitudinal length of 24.5 mm, and an outside lateral length of 24.5 mm to provide an evaluation sample.

The evaluation sample was bonded between the two kinds of laminated structural bodies (X) and (Y) obtained in the foregoing so as to be of a shape point-symmetric about its center, and was pressure-bonded (62 N×10 seconds) therebetween so that a force was uniformly applied thereto in a gravity direction. After that, the resultant was left at rest under an environment at 80° C. for 30 minutes, and was removed from the environment, followed by the returning of its temperature to 23° C. overnight. Thus, a test piece was obtained. A columnar measurement stand having a length of 50 mm, an outer diameter of 49 mm, and an inner diameter of 43 mm was placed on the base of a Dupont-type impact tester (manufactured by Toyo Seiki Seisaku-sho, Ltd.), and the test piece was mounted on the stand with its square stainless-steel plate (Y1) directed downward so as to be of a shape point-symmetric about the center. A stainless steel-made impactor having a tip radius of 3.1 mm was mounted on the test piece, and the weight of a falling weight and the falling height thereof were changed as follows so that energy increased until peeling between the laminated structural bodies occurred: the weight was set to 100 g, and the height was changed from 50 mm to 500 mm in increments of 50 mm; the weight was set to 150 g, and the height was changed from 350 mm to 500 mm in increments of 50 mm; the weight was set to 200 g, and the height was changed from 400 mm to 500 mm in increments of 50 mm; and the weight was set to 300 g, and the height was changed from 350 mm to 500 mm in increments of 50 mm. At this time, no test was performed for the energy that had already been evaluated, and the load and the height were set so that energy amounts did not overlap each other. After that, the energy before the peeling was determined from the product of the load and the height.

### [Production Example 1]: Production of Pressure-Sensitive Adhesive Sheet (1)

95 Parts of butyl acrylate (BA) and 5 parts of acrylic acid (AA) serving as monomer components, and 233 parts of ethyl acetate serving as a polymerization solvent were loaded into a reaction vessel including a stirring machine, a temperature gauge, a nitrogen gas-introducing tube, a reflux condenser, and a dropping funnel, and were stirred for 2 hours while a nitrogen gas was introduced into the vessel. After oxygen in the polymerization system had been removed as described above, 0.2 part of 2,2′-azobisisobutyronitrile was added as a polymerization initiator to the mixture, and the whole was subjected to solution polymerization at 60° C. for 8 hours to provide a solution of an acrylic polymer. The acrylic polymer had a weight-average molecular weight of 700,000.

20 Parts of a terpene-phenol resin (product name: “YS POLYSTER T-115”, softening point: about 115° C., hydroxyl value: from 30 mgKOH/g to 60 mgKOH/g, manufactured by Yasuhara Chemical Co., Ltd.) serving as a tackifying resin, 3 parts of an isocyanate-based cross-linking agent (product name: “CORONATE L”, 75% solution of a trimethylolpropane/tolylene diisocyanate trimer adduct in ethyl acetate, manufactured by Tosoh Corporation) and 0.02 part of an epoxy-based cross-linking agent (product name: “TETRAD-C”, 1,3-bis(N,N-diglycidylaminomethyl)cyclohexane, manufactured by Mitsubishi Gas Chemical Company, Inc.) serving as cross-linking agents, and 6 parts of a product available under the product name “AT-DN101 BLACK” (manufactured by Dainichiseika Color & Chemicals Mfg. Co., Ltd.) serving as a black pigment with respect to 100 parts of the acrylic polymer in the resultant acrylic polymer solution were added to the solution, and the contents were stirred and mixed to prepare a pressure-sensitive adhesive composition (1).

The pressure-sensitive adhesive composition (1) was applied to the release surface of a polyester release liner having a thickness of 38 μm (product name: “DIAFOIL MRF”, manufactured by Mitsubishi Polyester Film, Inc.), and was dried at 100° C. for 2 minutes to form a pressure-sensitive adhesive layer (1) having a thickness of 100 μm.

The two pressure-sensitive adhesive layer surfaces of the resultant pressure-sensitive adhesive layers (1) on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, a pressure-sensitive adhesive sheet (1) having a total thickness of 200 μm was obtained.

### [Production Example 2]: Production of Pressure-Sensitive Adhesive Sheet (2)

The pressure-sensitive adhesive composition (1) obtained in Production Example 1 was applied to the release surface of a polyester release liner having a thickness of 38 μm (product name: “DIAFOIL MRF”, manufactured by Mitsubishi Polyester Film, Inc.), and was dried at 100° C. for 2 minutes to form a pressure-sensitive adhesive layer (2) having a thickness of 95 μm.

Next, the pressure-sensitive adhesive layer surface of the pressure-sensitive adhesive layer (2) on which the release liner was not arranged was bonded to each of both surfaces of a urethane base material having a thickness of 10 μm (SILKLON NES85, manufactured by Okura Industrial Co., Ltd.). The resultant structural body was passed through a laminator (0.3 MPa, speed: 0.5 m/min) at room temperature once, and was then aged in an oven at 50° C. for 1 day. After that, the release liners were peeled off. Thus, a pressure-sensitive adhesive sheet (2) having a total thickness of 200 μm was obtained.

### [Production Example 3]: Production of Pressure-Sensitive Adhesive Sheet (3)

The pressure-sensitive adhesive composition (1) obtained in Production Example 1 was applied to the release surface of a polyester release liner having a thickness of 38 μm (product name: “DIAFOIL MRF”, manufactured by Mitsubishi Polyester Film, Inc.), and was dried at 100° C. for 2 minutes to form a pressure-sensitive adhesive layer (3) having a thickness of 87.5 μm.

Next, the pressure-sensitive adhesive layer surface of the pressure-sensitive adhesive layer (3) on which the release liner was not arranged was bonded to each of both surfaces of a urethane base material having a thickness of 25 μm (SILKLON NES85, manufactured by Okura Industrial Co., Ltd.). The resultant structural body was passed through a laminator (0.3 MPa, speed: 0.5 m/min) at room temperature once, and was then aged in an oven at 50° C. for 1 day. After that, the release liners were peeled off. Thus, a pressure-sensitive adhesive sheet (3) having a total thickness of 200 μm was obtained.

### [Production Example 4]: Production of Pressure-Sensitive Adhesive Sheet (4)

90 Parts of 2-ethylhexyl acrylate (2EHA) and 10 parts of acrylic acid serving as monomer components, and 200 parts of ethyl acetate serving as a polymerization solvent were loaded into a reaction vessel including a stirring machine, a temperature gauge, a nitrogen gas-introducing tube, a reflux condenser, and a dropping funnel, and were stirred for 2 hours while a nitrogen gas was introduced into the vessel. After oxygen in the polymerization system had been removed as described above, 0.2 part of benzoyl peroxide was added as a polymerization initiator to the mixture, and the whole was subjected to solution polymerization at 60° C. for 6 hours to provide a solution of an acrylic polymer according to this Example. The acrylic polymer had a weight-average molecular weight of 1,200,000.

20 Parts of a terpene-phenol resin (product name: “YS POLYSTER T-115”, softening point: about 115° C., hydroxyl value: from 30 mgKOH/g to 60 mgKOH/g, manufactured by Yasuhara Chemical Co., Ltd.) serving as a tackifying resin, 3 parts of an isocyanate-based cross-linking agent (product name: “CORONATE L”, 75% solution of a trimethylolpropane/tolylene diisocyanate trimer adduct in ethyl acetate, manufactured by Tosoh Corporation) and 0.02 part of an epoxy-based cross-linking agent (product name: “TETRAD-C”, 1,3-bis(N,N-diglycidylaminomethyl)cyclohexane, manufactured by Mitsubishi Gas Chemical Company, Inc.) serving as cross-linking agents, and 6 parts of a product available under the product name “AT-DN101 BLACK” (manufactured by Dainichiseika Color & Chemicals Mfg. Co., Ltd.) serving as a black pigment with respect to 100 parts of the acrylic polymer in the resultant acrylic polymer solution were added to the solution, and the contents were stirred and mixed to prepare a pressure-sensitive adhesive composition (4).

The pressure-sensitive adhesive composition (4) was applied to the release surface of a polyester release liner having a thickness of 38 μm (product name: “DIAFOIL MRF”, manufactured by Mitsubishi Polyester Film, Inc.), and was dried at 100° C. for 2 minutes to form a pressure-sensitive adhesive layer (4) having a thickness of 100 μm.

The two pressure-sensitive adhesive layer surfaces of the resultant pressure-sensitive adhesive layers (4) on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, a pressure-sensitive adhesive sheet (4) having a total thickness of 200 μm was obtained.

### [Production Example 5]: Production of Pressure-Sensitive Adhesive Sheet (5)

85 Parts of butyl acrylate and 15 parts of acrylic acid serving as monomer components, and 250 parts of ethyl acetate serving as a polymerization solvent were loaded into a reaction vessel including a stirring machine, a temperature gauge, a nitrogen gas-introducing tube, a reflux condenser, and a dropping funnel, and were stirred for 2 hours while a nitrogen gas was introduced into the vessel. After oxygen in the polymerization system had been removed as described above, 0.2 part of 2,2′-azobisisobutyronitrile was added as a polymerization initiator to the mixture, and the whole was subjected to solution polymerization at 60° C. for 8 hours to provide a solution of an acrylic polymer. The acrylic polymer had a weight-average molecular weight of 600,000.

20 Parts of a terpene-phenol resin (product name: “YS POLYSTER T-115”, softening point: about 115° C., hydroxyl value: from 30 mgKOH/g to 60 mgKOH/g, manufactured by Yasuhara Chemical Co., Ltd.) serving as a tackifying resin, 3 parts of an isocyanate-based cross-linking agent (product name: “CORONATE L”, 75% solution of a trimethylolpropane/tolylene diisocyanate trimer adduct in ethyl acetate, manufactured by Tosoh Corporation) and 0.02 part of an epoxy-based cross-linking agent (product name: “TETRAD-C”, 1,3-bis(N,N-diglycidylaminomethyl)cyclohexane, manufactured by Mitsubishi Gas Chemical Company, Inc.) serving as cross-linking agents, and 6 parts of a product available under the product name “AT-DN101 BLACK” (manufactured by Dainichiseika Color & Chemicals Mfg. Co., Ltd.) serving as a black pigment with respect to 100 parts of the acrylic polymer in the resultant acrylic polymer solution were added to the solution, and the contents were stirred and mixed to prepare a pressure-sensitive adhesive composition (5).

The pressure-sensitive adhesive composition (5) was applied to the release surface of a polyester release liner having a thickness of 38 μm (product name: “DIAFOIL MRF”, manufactured by Mitsubishi Polyester Film, Inc.), and was dried at 100° C. for 2 minutes to form a pressure-sensitive adhesive layer (5) having a thickness of 100 μm.

The two pressure-sensitive adhesive layer surfaces of the resultant pressure-sensitive adhesive layers (5) on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, a pressure-sensitive adhesive sheet (5) having a total thickness of 200 μm was obtained.

### [Example 1]: Production of Laminate (1)

A stainless-steel plate (SUS304BA plate) (manufactured by Nippon Kinzoku Co., Ltd.) washed with toluene, a polycarbonate plate (manufactured by Mitsubishi Chemical Corporation) washed with isopropyl alcohol, and an aluminum plate (manufactured by Nippon Testpanel Co., Ltd.) were adopted as adherends (a), (b), and (c), respectively, and a water dispersion of a self-emulsifying aqueous urethane resin having an elongation of 330% (“SUPERFLEX 150”, nonvolatile content=30±1 wt %, manufactured by DKS Co., Ltd.) was uniformly applied onto the surface of each of these adherends with an applicator (manufactured by AS ONE Corporation, 1-3777-01) so as to have a thickness of 3.00 μm. After that, the resultant was dried in an oven at 70° C. for 5 minutes to produce a laminated structural body of a reinforcing agent layer (1) and each of the three kinds of adherends (a), (b), and (c).

By one pass back and forth with a 2 kg roller, one pressure-sensitive adhesive layer surface of the pressure-sensitive adhesive sheet (1) obtained in Production Example 1 was pressure-bonded to each of the laminated structural bodies to produce a laminate (1a), (1b), or (1c) of the pressure-sensitive adhesive sheet (1), the reinforcing agent layer (1), and the adherend (a), (b), or (c).

The results are shown in Table 1.

### [Example 2]: Production of Laminate (2)

A laminate (2a), (2b), or (2c) of the pressure-sensitive adhesive sheet (1), a reinforcing agent layer (2), and the adherend (a), (b), or (c) was obtained in the same manner as in Example 1 except that the water dispersion of the self-emulsifying aqueous urethane resin having an elongation of 330% (“SUPERFLEX 150”, nonvolatile content=30±1 wt %, manufactured by DKS Co., Ltd.) was uniformly applied onto the surface of each of the adherends so as to have a thickness of 1.50 μm.

The results are shown in Table 1.

### [Example 3]: Production of Laminate (3)

A laminate (3a), (3b), or (3c) of the pressure-sensitive adhesive sheet (1), a reinforcing agent layer (3), and the adherend (a), (b), or (c) was obtained in the same manner as in Example 1 except that the water dispersion of the self-emulsifying aqueous urethane resin having an elongation of 330% (“SUPERFLEX 150”, nonvolatile content=30±1 wt %, manufactured by DKS Co., Ltd.) was uniformly applied onto the surface of each of the adherends so as to have a thickness of 0.75 μm.

The results are shown in Table 1.

### [Example 4]: Production of Laminate (4)

A laminate (4a), (4b), or (4c) of the pressure-sensitive adhesive sheet (1), a reinforcing agent layer (4), and the adherend (a), (b), or (c) was obtained in the same manner as in Example 1 except that the water dispersion of the self-emulsifying aqueous urethane resin having an elongation of 330% (“SUPERFLEX 150”, nonvolatile content=30±1 wt %, manufactured by DKS Co., Ltd.) was uniformly applied onto the surface of each of the adherends so as to have a thickness of 0.38 μm.

The results are shown in Table 1.

### [Example 5]: Production of Laminate (5)

A laminate (5a), (5b), or (5c) of the pressure-sensitive adhesive sheet (1), a reinforcing agent layer (5), and the adherend (a), (b), or (c) was obtained in the same manner as in Example 1 except that the water dispersion of the self-emulsifying aqueous urethane resin having an elongation of 330% (“SUPERFLEX 150”, nonvolatile content=30±1 wt %, manufactured by DKS Co., Ltd.) was uniformly applied onto the surface of each of the adherends so as to have a thickness of 0.19 μm.

The results are shown in Table 1.

### [Example 6]: Production of Laminate (6)

A laminate (6a), (6b), or (6c) of the pressure-sensitive adhesive sheet (2), the reinforcing agent layer (1), and the adherend (a), (b), or (c) was obtained in the same manner as in Example 1 except that the pressure-sensitive adhesive sheet (1) was changed to the pressure-sensitive adhesive sheet (2) obtained in Production Example 2.

The results are shown in Table 1.

### [Example 7]: Production of Laminate (7)

A laminate (7a), (7b), or (7c) of the pressure-sensitive adhesive sheet (2), the reinforcing agent layer (2), and the adherend (a), (b), or (c) was obtained in the same manner as in Example 2 except that the pressure-sensitive adhesive sheet (1) was changed to the pressure-sensitive adhesive sheet (2) obtained in Production Example 2.

The results are shown in Table 1.

### [Example 8]: Production of Laminate (8)

A laminate (8a), (8b), or (8c) of the pressure-sensitive adhesive sheet (2), the reinforcing agent layer (3), and the adherend (a), (b), or (c) was obtained in the same manner as in Example 3 except that the pressure-sensitive adhesive sheet (1) was changed to the pressure-sensitive adhesive sheet (2) obtained in Production Example 2.

The results are shown in Table 1.

### [Example 9]: Production of Laminate (9)

A laminate (9a), (9b), or (9c) of the pressure-sensitive adhesive sheet (2), the reinforcing agent layer (4), and the adherend (a), (b), or (c) was obtained in the same manner as in Example 4 except that the pressure-sensitive adhesive sheet (1) was changed to the pressure-sensitive adhesive sheet (2) obtained in Production Example 2.

The results are shown in Table 1.

### [Example 10]: Production of Laminate (10)

A laminate (10a), (10b), or (10c) of the pressure-sensitive adhesive sheet (2), the reinforcing agent layer (5), and the adherend (a), (b), or (c) was obtained in the same manner as in Example 5 except that the pressure-sensitive adhesive sheet (1) was changed to the pressure-sensitive adhesive sheet (2) obtained in Production Example 2.

The results are shown in Table 1.

### [Example 11]: Production of Laminate (11)

A laminate (11a), (11b), or (11c) of the pressure-sensitive adhesive sheet (3), the reinforcing agent layer (1), and the adherend (a), (b), or (c) was obtained in the same manner as in Example 1 except that the pressure-sensitive adhesive sheet (1) was changed to the pressure-sensitive adhesive sheet (3) obtained in Production Example 3.

The results are shown in Table 1.

### [Example 12]: Production of Laminate (12)

A laminate (12a), (12b), or (12c) of the pressure-sensitive adhesive sheet (3), the reinforcing agent layer (2), and the adherend (a), (b), or (c) was obtained in the same manner as in Example 2 except that the pressure-sensitive adhesive sheet (1) was changed to the pressure-sensitive adhesive sheet (3) obtained in Production Example 3.

The results are shown in Table 1.

### [Example 13]: Production of Laminate (13)

A laminate (13a), (13b), or (13c) of the pressure-sensitive adhesive sheet (3), the reinforcing agent layer (3), and the adherend (a), (b), or (c) was obtained in the same manner as in Example 3 except that the pressure-sensitive adhesive sheet (1) was changed to the pressure-sensitive adhesive sheet (3) obtained in Production Example 3.

The results are shown in Table 1.

### [Example 14]: Production of Laminate (14)

A laminate (14a), (14b), or (14c) of the pressure-sensitive adhesive sheet (3), the reinforcing agent layer (4), and the adherend (a), (b), or (c) was obtained in the same manner as in Example 4 except that the pressure-sensitive adhesive sheet (1) was changed to the pressure-sensitive adhesive sheet (3) obtained in Production Example 3.

The results are shown in Table 1.

### [Example 15]: Production of Laminate (15)

A laminate (15a), (15b), or (15c) of the pressure-sensitive adhesive sheet (3), the reinforcing agent layer (5), and the adherend (a), (b), or (c) was obtained in the same manner as in Example 5 except that the pressure-sensitive adhesive sheet (1) was changed to the pressure-sensitive adhesive sheet (3) obtained in Production Example 3.

The results are shown in Table 1.

### [Example 16]: Production of Laminate (16)

A laminate (16a), (16b), or (16c) of the pressure-sensitive adhesive sheet (1), a reinforcing agent layer (16), and the adherend (a), (b), or (c) was obtained in the same manner as in Example 1 except that the water dispersion of the self-emulsifying aqueous urethane resin having an elongation of 330% (“SUPERFLEX 150”, nonvolatile content=30±1 wt %, manufactured by DKS Co., Ltd.) was changed to a water dispersion of a self-emulsifying aqueous urethane resin having an elongation of 750% (“SUPERFLEX 460”, nonvolatile content=38±1 wt %, manufactured by DKS Co., Ltd.).

The results are shown in Table 2.

### [Example 17]: Production of Laminate (17)

A laminate (17a), (17b), or (17c) of the pressure-sensitive adhesive sheet (1), a reinforcing agent layer (17), and the adherend (a), (b), or (c) was obtained in the same manner as in Example 2 except that the water dispersion of the self-emulsifying aqueous urethane resin having an elongation of 330% (“SUPERFLEX 150”, nonvolatile content=30±1 wt %, manufactured by DKS Co., Ltd.) was changed to a water dispersion of a self-emulsifying aqueous urethane resin having an elongation of 750% (“SUPERFLEX 460”, nonvolatile content=38±1 wt %, manufactured by DKS Co., Ltd.).

The results are shown in Table 2.

### [Example 18]: Production of Laminate (18)

A laminate (18a), (18b), or (18c) of the pressure-sensitive adhesive sheet (2), a reinforcing agent layer (18), and the adherend (a), (b), or (c) was obtained in the same manner as in Example 6 except that the water dispersion of the self-emulsifying aqueous urethane resin having an elongation of 330% (“SUPERFLEX 150”, nonvolatile content=30±1 wt %, manufactured by DKS Co., Ltd.) was changed to a water dispersion of a self-emulsifying aqueous urethane resin having an elongation of 750% (“SUPERFLEX 460”, nonvolatile content=38±1 wt %, manufactured by DKS Co., Ltd.).

The results are shown in Table 2.

### [Example 19]: Production of Laminate (19)

A laminate (19a), (19b), or (19c) of the pressure-sensitive adhesive sheet (2), a reinforcing agent layer (19), and the adherend (a), (b), or (c) was obtained in the same manner as in Example 7 except that the water dispersion of the self-emulsifying aqueous urethane resin having an elongation of 330% (“SUPERFLEX 150”, nonvolatile content=30±1 wt %, manufactured by DKS Co., Ltd.) was changed to a water dispersion of a self-emulsifying aqueous urethane resin having an elongation of 750% (“SUPERFLEX 460”, nonvolatile content=38±1 wt %, manufactured by DKS Co., Ltd.).

The results are shown in Table 2.

### [Example 20]: Production of Laminate (20)

A laminate (20a), (20b), or (20c) of the pressure-sensitive adhesive sheet (3), a reinforcing agent layer (20), and the adherend (a), (b), or (c) was obtained in the same manner as in Example 11 except that the water dispersion of the self-emulsifying aqueous urethane resin having an elongation of 330% (“SUPERFLEX 150”, nonvolatile content=30±1 wt %, manufactured by DKS Co., Ltd.) was changed to a water dispersion of a self-emulsifying aqueous urethane resin having an elongation of 750% (“SUPERFLEX 460”, nonvolatile content=38±1 wt %, manufactured by DKS Co., Ltd.).

The results are shown in Table 2.

### [Example 21]: Production of Laminate (21)

A laminate (21a), (21b), or (21c) of the pressure-sensitive adhesive sheet (3), a reinforcing agent layer (21), and the adherend (a), (b), or (c) was obtained in the same manner as in Example 12 except that the water dispersion of the self-emulsifying aqueous urethane resin having an elongation of 330% (“SUPERFLEX 150”, nonvolatile content=30±1 wt %, manufactured by DKS Co., Ltd.) was changed to a water dispersion of a self-emulsifying aqueous urethane resin having an elongation of 750% (“SUPERFLEX 460”, nonvolatile content=38±1 wt %, manufactured by DKS Co., Ltd.).

The results are shown in Table 2.

### [Example 22]: Production of Laminate (22)

A laminate (22a), (22b), or (22c) of the pressure-sensitive adhesive sheet (1), a reinforcing agent layer (22), and the adherend (a), (b), or (c) was obtained in the same manner as in Example 1 except that the water dispersion of the self-emulsifying aqueous urethane resin having an elongation of 330% (“SUPERFLEX 150”, nonvolatile content=30±1 wt %, manufactured by DKS Co., Ltd.) was changed to a water dispersion of a self-emulsifying aqueous urethane resin having an elongation of 340% (“SUPERFLEX 650”, nonvolatile content=26±1 wt %, manufactured by DKS Co., Ltd.).

The results are shown in Table 2.

### [Example 23]: Production of Laminate (23)

A laminate (23a), (23b), or (23c) of the pressure-sensitive adhesive sheet (2), a reinforcing agent layer (23), and the adherend (a), (b), or (c) was obtained in the same manner as in Example 6 except that the water dispersion of the self-emulsifying aqueous urethane resin having an elongation of 330% (“SUPERFLEX 150”, nonvolatile content=30±1 wt %, manufactured by DKS Co., Ltd.) was changed to a water dispersion of a self-emulsifying aqueous urethane resin having an elongation of 340% (“SUPERFLEX 650”, nonvolatile content=26±1 wt %, manufactured by DKS Co., Ltd.).

The results are shown in Table 2.

### [Example 24]: Production of Laminate (24)

A laminate (24a), (24b), or (24c) of the pressure-sensitive adhesive sheet (3), a reinforcing agent layer (24), and the adherend (a), (b), or (c) was obtained in the same manner as in Example 11 except that the water dispersion of the self-emulsifying aqueous urethane resin having an elongation of 330% (“SUPERFLEX 150”, nonvolatile content=30±1 wt %, manufactured by DKS Co., Ltd.) was changed to a water dispersion of a self-emulsifying aqueous urethane resin having an elongation of 340% (“SUPERFLEX 650”, nonvolatile content=26±1 wt %, manufactured by DKS Co., Ltd.).

The results are shown in Table 2.

### [Comparative Example 1]: Production of Laminate (C1)

A laminate (C1a), (C1b), or (C1c) of the pressure-sensitive adhesive sheet (1) and the adherend (a), (b), or (c) was obtained in the same manner as in Example 1 except that the reinforcing agent layer (1) was not arranged.

The results are shown in Table 3.

### [Comparative Example 2]: Production of Laminate (C2)

A laminate (C2a), (C2b), or (C2c) of the pressure-sensitive adhesive sheet (1), a reinforcing agent layer (C2), and the adherend (a), (b), or (c) was obtained in the same manner as in Example 1 except that the water dispersion of the self-emulsifying aqueous urethane resin having an elongation of 330% (“SUPERFLEX 150”, nonvolatile content=30±1 wt %, manufactured by DKS Co., Ltd.) was changed to a water dispersion of a self-emulsifying aqueous urethane resin having an elongation of 4% (“SUPERFLEX 870”, nonvolatile content=30±1 wt %, manufactured by DKS Co., Ltd.).

The results are shown in Table 3.

### [Comparative Example 3]: Production of Laminate (C3)

A laminate (C3a), (C3b), or (C3c) of the pressure-sensitive adhesive sheet (2), a reinforcing agent layer (C3), and the adherend (a), (b), or (c) was obtained in the same manner as in Example 6 except that the water dispersion of the self-emulsifying aqueous urethane resin having an elongation of 330% (“SUPERFLEX 150”, nonvolatile content=30±1 wt %, manufactured by DKS Co., Ltd.) was changed to a water dispersion of a self-emulsifying aqueous urethane resin having an elongation of 4% (“SUPERFLEX 870”, nonvolatile content=30±1 wt %, manufactured by DKS Co., Ltd.).

The results are shown in Table 3.

### [Comparative Example 4]: Production of Laminate (C4)

A laminate (C4a), (C4b), or (C4c) of the pressure-sensitive adhesive sheet (1), a reinforcing agent layer (C4), and the adherend (a), (b), or (c) was obtained in the same manner as in Example 1 except that the water dispersion of the self-emulsifying aqueous urethane resin having an elongation of 330% (“SUPERFLEX 150”, nonvolatile content=30±1 wt %, manufactured by DKS Co., Ltd.) was changed to a water dispersion of a self-emulsifying aqueous urethane resin having an elongation of 5% (“SUPERFLEX 830HS”, nonvolatile content=27±1 wt %, manufactured by DKS Co., Ltd.).

The results are shown in Table 3.

### [Comparative Example 5]: Production of Laminate (C5)

A laminate (C5a), (C5b), or (C5c) of the pressure-sensitive adhesive sheet (2), a reinforcing agent layer (C5), and the adherend (a), (b), or (c) was obtained in the same manner as in Example 6 except that the water dispersion of the self-emulsifying aqueous urethane resin having an elongation of 330% (“SUPERFLEX 150”, nonvolatile content=30±1 wt %, manufactured by DKS Co., Ltd.) was changed to a water dispersion of a self-emulsifying aqueous urethane resin having an elongation of 5% (“SUPERFLEX 210”, nonvolatile content=35±1 wt %, manufactured by DKS Co., Ltd.).

The results are shown in Table 3.

### [Comparative Example 6]: Production of Laminate (C6)

A laminate (C6a), (C6b), or (C6c) of the pressure-sensitive adhesive sheet (1), a reinforcing agent layer (C6), and the adherend (a), (b), or (c) was obtained in the same manner as in Example 1 except that the water dispersion of the self-emulsifying aqueous urethane resin having an elongation of 330% (“SUPERFLEX 150”, nonvolatile content=30±1 wt %, manufactured by DKS Co., Ltd.) was changed to a water dispersion of a self-emulsifying aqueous urethane resin having an elongation of 1,500% (“SUPERFLEX 300”, nonvolatile content=30±1 wt %, manufactured by DKS Co., Ltd.).

The results are shown in Table 3.

### [Comparative Example 7]: Production of Laminate (C7)

A laminate (C7a), (C7b), or (C7c) of the pressure-sensitive adhesive sheet (4), the reinforcing agent layer (1), and the adherend (a), (b), or (c) was obtained in the same manner as in Example 1 except that the pressure-sensitive adhesive sheet (1) was changed to the pressure-sensitive adhesive sheet (4) obtained in Production Example 4.

The results are shown in Table 3.

### [Comparative Example 8]: Production of Laminate (C8)

A laminate (C8a), (C8b), or (C8c) of the pressure-sensitive adhesive sheet (5), the reinforcing agent layer (17), and the adherend (a), (b), or (c) was obtained in the same manner as in Example 17 except that the pressure-sensitive adhesive sheet (1) was changed to the pressure-sensitive adhesive sheet (5) obtained in Production Example 5.

The results are shown in Table 3.

TABLE 1

| Example | | | Example 1 | Example 2 | Example 3 |
|---|---|---|---|---|---|
| Pressure- | Monomer | Kind | BA/AA = 95:5 | BA/AA = 95:5 | BA/AA = 95:5 |
| sensitive | component | Part(s) by weight | 100 | 100 | 100 |
| adhesive | Tackifier | YS POLYSTER T-115 | 20 | 20 | 20 |
| sheet | | (Part(s) by weight) | | | |
| | Cross- | TETRAD-C | 0.02 | 0.02 | 0.02 |
| | linking | (Part(s) by weight) | | | |
| | agent | | | | |
| | Cross- | CORONATE L | 3 | 3 | 3 |
| | linking | (Part(s) by weight) | | | |
| | agent | | | | |
| | Additive | AT-DN101 | 6 | 6 | 6 |
| | | (Part(s) by weight) | | | |

| | | | | |
|---|---|---|---|---|
| | Kind of base material | None | None | None |
| | Thickness of base material (μm) | — | — | — |
| | Total thickness (μm) | 200 | 200 | 200 |
| Reinforcing | Product name | SF150 | SF150 | SF150 |
| agent | Kind | Aqueous | Aqueous | Aqueous |
| layer | | polyurethane, | polyurethane, | polyurethane, |
| | | non-yellowing | non-yellowing | non-yellowing |
| | | isocyanate, | isocyanate, | isocyanate, |
| | | ester-based | ester-based | ester-based |
| | | skeleton, | skeleton, | skeleton, |
| | | ether-based | ether-based | ether-based |
| | | skeleton | skeleton | skeleton |
| | Elongation (%) | 330 | 330 | 330 |
| | Thickness (μm) | 3.00 | 1.50 | 0.75 |
| Characteristic | Adhesive strength (N/20 mm) | 32 | 32 | 34 |
| | for SUS | | | |
| | Adhesive strength (N/20 mm) | 34 | 33 | 34 |
| | for polycarbonate | | | |
| | Adhesive strength (N/20 mm) | 34 | 33 | 33 |
| | for aluminum | | | |
| | Impact resistance (J) for SUS | 0.40 | 0.52 | 0.52 |

| Example | Example 4 | Example 5 | Example 6 | Example 7 | Example 8 |
|---|---|---|---|---|---|
| Pressure- | BA/AA = 95:5 | BA/AA = 95:5 | BA/AA = 95:5 | BA/AA = 95:5 | BA/AA = 95:5 |
| sensitive | 100 | 100 | 100 | 100 | 100 |
| adhesive | 20 | 20 | 20 | 20 | 20 |
| sheet | | | | | |
| | 0.02 | 0.02 | 0.02 | 0.02 | 0.02 |
| | 3 | 3 | 3 | 3 | 3 |
| | 6 | 6 | 6 | 6 | 6 |
| | None | None | Polyester- | Polyester- | Polyester- |
| | | | based | based | based |
| | | | urethane | urethane | urethane |
| | — | — | 10 | 10 | 10 |
| | 200 | 200 | 200 | 200 | 200 |
| Reinforcing | SF150 | SF150 | SF150 | SF150 | SF150 |
| agent | Aqueous | Aqueous | Aqueous | Aqueous | Aqueous |
| layer | polyurethane, | polyurethane, | polyurethane, | polyurethane, | polyurethane, |
| | non-yellowing | non-yellowing | non-yellowing | non-yellowing | non-yellowing |
| | isocyanate, | isocyanate, | isocyanate, | isocyanate, | isocyanate, |
| | ester-based | ester-based | ester-based | ester-based | ester-based |
| | skeleton, | skeleton, | skeleton, | skeleton, | skeleton, |
| | ether-based | ether-based | ether-based | ether-based | ether-based |
| | skeleton | skeleton | skeleton | skeleton | skeleton |
| | 330 | 330 | 330 | 330 | 330 |
| | 0.38 | 0.19 | 3.00 | 1.50 | 0.75 |
| Characteristic | 33 | 32 | 32 | 32 | 34 |
| | 34 | 33 | 34 | 33 | 34 |
| | 33 | 34 | 34 | 33 | 33 |
| | 0.56 | 0.57 | 0.40 | 0.52 | 0.52 |

| Example | | | Example 9 | Example 10 | Example 11 |
|---|---|---|---|---|---|
| Pressure- | Monomer | Kind | BA/AA = 95:5 | BA/AA = 95:5 | BA/AA = 95:5 |
| sensitive | component | Part(s) by weight | 100 | 100 | 100 |
| adhesive | Tackifier | YS POLYSTER T-115 | 20 | 20 | 20 |
| sheet | | (Part(s) by weight) | | | |
| | Cross- | TETRAD-C | 0.02 | 0.02 | 0.02 |
| | linking | (Part(s) by weight) | | | |
| | agent | | | | |
| | Cross- | CORONATE L | 3 | 3 | 3 |
| | linking | (Part(s) by weight) | | | |
| | agent | | | | |
| | Additive | AT-DN101 | 6 | 6 | 6 |
| | | (Part(s) by weight) | | | |

| | | | | |
|---|---|---|---|---|
| | Kind of base material | Polyester- | Polyester- | Polyester- |
| | | based | based | based |
| | | urethane | urethane | urethane |
| | Thickness of base material (μm) | 10 | 10 | 25 |
| | Total thickness (μm) | 200 | 200 | 200 |
| Reinforcing | Product name | SF150 | SF150 | SF150 |
| agent | Kind | Aqueous | Aqueous | Aqueous |
| layer | | polyurethane, | polyurethane, | polyurethane, |
| | | non-yellowing | non-yellowing | non-yellowing |
| | | ieocyanate, | ieocyanate, | ieocyanate, |
| | | ester-based | ester-based | ester-based |
| | | skeleton, | skeleton, | skeleton, |
| | | ether-based | ether-based | ether-based |
| | | skeleton | skeleton | skeleton |
| | Elongation (%) | 330 | 330 | 330 |
| | Thickness (μm) | 0.38 | 0.19 | 3.00 |
| Characteristic | Adhesive strength (N/20 mm) | 33 | 32 | 32 |
| | for SUS | | | |
| | Adhesive strength (N/2G mm) | 34 | 33 | 34 |
| | for polycarbonate | | | |
| | Adhesive strength (N/20 mm) | 33 | 34 | 34 |
| | for aluminum | | | |
| | Impact resistance (J) for SUS | 0.56 | 0.57 | 0.40 |

| Example | Example 12 | Example 13 | Example 14 | Example 15 |
|---|---|---|---|---|
| Pressure- | BA/AA = 95:5 | BA/AA = 95:5 | BA/AA = 95:5 | BA/AA = 95:5 |
| sensitive | 100 | 100 | 100 | 100 |
| adhesive | 20 | 20 | 20 | 20 |
| sheet | | | | |
| | 0.02 | 0.02 | 0.02 | 0.02 |
| | 3 | 3 | 3 | 3 |
| | 6 | 6 | 6 | 6 |
| | Polyester- | Polyester- | Polyester- | Polyester- |
| | based | based | based | based |
| | urethane | urethane | urethane | urethane |
| | 25 | 25 | 25 | 25 |
| | 200 | 200 | 200 | 200 |
| Reinforcing | SF150 | SF150 | SF150 | SF150 |
| agent | Aqueous | Aqueous | Aqueous | Aqueous |
| layer | polyurethane, | polyurethane, | polyurethane, | polyurethane, |
| | non-yellowing | non-yellowing | non-yellowing | non-yellowing |
| | isocyanate, | isocyanate, | isocyanate, | isocyanate, |
| | ester-based | ester-based | ester-based | ester-based |
| | skeleton, | skeleton, | skeleton, | skeleton, |
| | ether-based | ether-based | ether-based | ether-based |
| | skeleton | skeleton | skeleton | skeleton |
| | 330 | 330 | 330 | 330 |
| | 1.50 | 0.75 | 0.38 | 0.19 |
| Characteristic | 32 | 34 | 33 | 32 |
| | 33 | 34 | 34 | 33 |
| | 33 | 33 | 33 | 34 |
| | 0.52 | 0.52 | 0.56 | 0.57 |

TABLE 2

| Example | | | Example 16 | Example 17 | Example 18 |
|---|---|---|---|---|---|
| Pressure- | Monomer | Kind | BA/AA = 95:5 | BA/AA = 95:5 | BA/AA = 95:S |
| sensitive | component | Part(s) by weight | 100 | 100 | 100 |
| adhesive | Tackifier | YS POLYSTER T-115 | 20 | 20 | 20 |
| sheet | | (Part(s) by weight) | | | |
| | Cross- | TETRAD-C | 0.02 | 0.02 | 0.02 |
| | linking | (Part(s) by weight) | | | |
| | agent | | | | |
| | Cross- | CORONATE L | 3 | 3 | 3 |
| | linking | (Part(s) by weight) | | | |
| | agent | | | | |
| | Additive | AT-DN101 | 6 | 6 | 6 |
| | | (Part(s) by weight) | | | |

| | | | | |
|---|---|---|---|---|
| | Kind of base material | None | None | Polyester- |
| | | | | based |
| | | | | urethane |
| | Thickness of base material (μm) | — | — | 10 |
| | Total thickness (μm) | 200 | 200 | 200 |
| Reinforcing | Product name | SF460 | SF460 | SF460 |
| agent | Kind | Aqueous | Aqueous | Aqueous |
| layer | | polyurethane, | polyurethane, | polyurethane, |
| | | non-yellowing | non-yellowing | non-yellowing |
| | | isocyanate, | isocyanate, | isocyanate, |
| | | carbonate- | carbonate- | carbonate- |
| | | based | based | based |
| | | skeleton | skeleton | skeleton |
| | Elongation (%) | 750 | 750 | 750 |
| | Thickness (μm) | 3.00 | 1.50 | 3.00 |
| Characteristic | Adhesive strength (N/20 mm) | 28 | 28 | 28 |
| | for SUS | | | |
| | Adhesive strength (N/20 mm) | 26 | 27 | 26 |
| | for polycarbonate | | | |
| | Adhesive strength (N/20 mm) | 25 | 26 | 25 |
| | for aluminum | | | |
| | Impact resistance (J) for SUS | 0.41 | 0.52 | 0.41 |

| Example | Example 19 | Example 20 | Example 21 |
|---|---|---|---|
| Pressure- | BA/AA = 95:5 | BA/AA = 95:5 | BA/AA = 95:5 |
| sensitive | 100 | 100 | 100 |
| adhesive | 20 | 20 | 20 |
| sheet | | | |
| | 0.02 | 0.02 | 0.02 |
| | 3 | 3 | 3 |
| | 6 | 6 | 6 |
| | Polyester- | Polyester- | Polyester- |
| | based | based | based |
| | urethane | urethane | urethane |
| | 10 | 25 | 25 |
| | 200 | 200 | 200 |
| Reinforcing | SF460 | SF460 | SF460 |
| agent | Aqueous | Aqueous | Aqueous |
| layer | polyurethane, | polyurethane, | polyurethane, |
| | non-yellowing | non-yellowing | non-yellowing |
| | isocyanate, | isocyanate, | isocyanate, |
| | carbonate- | carbonate- | carbonate- |
| | based | based | based |
| | skeleton | skeleton | skeleton |
| | 750 | 750 | 750 |
| | 1.50 | 3.00 | 1.50 |
| Characteristic | 28 | 28 | 28 |
| | 27 | 26 | 27 |
| | 26 | 25 | 26 |
| | 0.52 | 0.41 | 0.52 |

| Example | | | Example 22 | Example 23 | Example 24 |
|---|---|---|---|---|---|
| Pressure- | Monomer | Kind | BA/AA = 95:5 | BA/AA = 95:5 | BA/AA = 95:5 |
| sensitive | component | Part(s) by weight | 100 | 100 | 100 |
| adhesive | Tackifier | YS POLYSTER T-115 | 20 | 20 | 20 |
| sheet | | (Part(s) by weight) | | | |
| | Cross- | TETRAD-C | 0.02 | 0.02 | 0.02 |
| | linking | (Part(s) by weight) | | | |
| | agent | | | | |
| | Cross- | CORONATE L | 3 | 3 | 3 |
| | linking | (Part(s) by weight) | | | |
| | agent | | | | |
| | Additive | AT-DN101 | 6 | 6 | 6 |
| | | (Part(s) by weight) | | | |

| | | | | |
|---|---|---|---|---|
| | Kind of base material | None | Polyester- | Polyester- |
| | | | based | based |
| | | | urethane | urethane |
| | Thickness of base material (μm) | — | 10 | 25 |
| | Total thickness (μm) | 200 | 200 | 200 |
| Reinforcing | Product name | SF650 | SF650 | SF650 |
| agent | Kind | Aqueous | Aqueous | Aqueous |
| layer | | polyurethane, | polyurethane, | polyurethane, |
| | | non-yellowing | non-yellowing | non-yellowing |
| | | isocyanate, | isocyanate, | isocyanate, |
| | | carbonate- | carbonate- | carbonate- |
| | | based | based | based |
| | | skeleton | skeleton | skeleton |
| | Elongation (%) | 340 | 340 | 340 |
| | Thickness (μm) | 3.00 | 3.00 | 3.00 |
| Characteristic | Adhesive strength (N/20 mm) | 26 | 26 | 26 |
| | for SUS | | | |
| | Adhesive strength (N/20 mm) | 28 | 28 | 28 |
| | for polycarbonate | | | |
| | Adhesive strength (N/20 mm) | 29 | 29 | 29 |
| | for aluminum | | | |
| | Impact resistance (J) for SUS | 0.39 | 0.39 | 0.39 |

TABLE 3

| Comparative | | | Comparative | Comparative | Comparative | Comparative |
|---|---|---|---|---|---|---|
| Example | | | Example 1 | Example 2 | Example 3 | Example 4 |
| Pressure- | Monomer | Kind | BA/AA = 95:5 | BA/AA = 95:5 | BA/AA = 95:5 | BA/AA = 95:5 |
| sensitive | component | Part(s) by weight | 100 | 100 | 100 | 100 |
| adhesive | | | | | | |
| sheet | Tackifier | YS POLLSTER T-115 | 20 | 20 | 20 | 20 |
| | | (Part(s) by weight) | | | | |
| | Cross- | TETRAD-C | 0.02 | 0.02 | 0.02 | 0.02 |
| | linking | (Part(s) by weight) | | | | |
| | agent | | | | | |
| | Cross- | CORONATE L | 3 | 3 | 3 | 3 |
| | linking | (Part(s) by weight) | | | | |
| | agent | | | | | |
| | Additive | AT-DN101 | 6 | 6 | 6 | 6 |
| | | (Part(s) by weight) | | | | |

| | | | | | |
|---|---|---|---|---|---|
| | Kind of base material | None | None | Polyester- | None |
| | | | | based | |
| | | | | urethane | |
| | Thickness of base material (μm) | — | — | 10 | — |
| | Total thickness (μm) | 200 | 200 | 200 | 200 |
| Reinforcing | Product name | Blank | SF870 | SF870 | SF830HS |
| agent | Kind | — | Aqueous | Aqueous | Aqueous |
| layer | | | polyurethane, | polyurethane, | polyurethane, |
| | | | aromatic | aromatic | aromatic |
| | | | isocyanate, | isocyanate, | isocyanate, |
| | | | ether-based | ether-based | ester-based |
| | | | skeleton | skeleton | skeleton |
| | Elongation (%) | | 4 | 4 | 5 |
| | Thickness (μm) | — | 0.19 | 3.00 | 0.50 |
| Characteristic | Adhesive strength (N/20 mm) | 16 | 12 | 12 | 16 |
| | for SUS | | | | |
| | Adhesive strength (N/20 mm) | 18 | 18 | 18 | 18 |
| | for polycarbonate | | | | |
| | Adhesive strength (N/20 mm) | 16 | 16 | 16 | 17 |
| | for aluminum | | | | |
| | Impact resistance (J) for SUS | 0.32 | 0.27 | 0.3 | 0.15 |

| Comparative | Comparative | Comparative | Comparative | Comparative |
|---|---|---|---|---|
| Example | Example 5 | Example 6 | Example 7 | Example 8 |
| Pressure- | BA/AA = 95:5 | BA/AA = 95:5 | 2EHA/AA = 90:10 | BA/AA = 85:15 |
| sensitive | 100 | 100 | 100 | 100 |
| adhesive | | | | |
| sheet | 20 | 20 | 20 | 20 |
| | 0.02 | 0.02 | 0.02 | 0.02 |
| | 3 | 3 | 3 | 3 |
| | 6 | 6 | 6 | 6 |
| | Polyester- | None | None | None |
| | based | | | |
| | urethane | | | |
| | 10 | — | — | — |
| | 200 | 200 | 200 | 200 |
| Reinforcing | SF210 | SF300 | SF150 | SF460 |
| agent | Aqueous | Aqueous | Aqueous | Aqueous |
| layer | polyurethane, | polyurethane, | polyurethane, | polyurethane, |
| | non-yellowing | non-yellowing | non-yellowing | non-yellowing |
| | isocyanate, | isocyanate, | isocyanate, | isocyanate, |
| | ester-based | ester-based | ester-based | carbonate- |
| | skeleton | skeleton, | skeleton, | based |
| | | ether-based | ether-based | skeleton |
| | | skeleton | skeleton | |
| | 5 | 1,500 | 330 | 750 |
| | 2.00 | 1.00 | 3.00 | 1.50 |
| Characteristic | 16 | 0.42 | 14 | 11 |
| | 19 | 0.51 | 17 | 7 |
| | 16 | 0.41 | 15 | 8 |
| | 0.11 | 0.12 | 0.11 | 0.09 |

The laminate according to at least one embodiment of the present invention is typically used for an electronic device, and may be utilized in, for example, an article including an electronic device member (typically a mobile device).

According to at least one embodiment of the present invention, the laminate including a laminated structure of a pressure-sensitive adhesive sheet, a reinforcing agent layer, and an adherend, the laminate being capable of expressing both of a high adhesive strength and high impact resistance, can be provided.

What is claimed is:

1. A laminate, comprising a laminated structure of a pressure-sensitive adhesive sheet, a reinforcing agent layer, and an adherend,
wherein an outermost layer of the pressure-sensitive adhesive sheet on a reinforcing agent layer side is a pressure-sensitive adhesive layer,
wherein the laminate shows an adhesive strength of 20 N/20 mm or more when the pressure-sensitive adhesive sheet is peeled from a laminated structural body of the pressure-sensitive adhesive sheet, the reinforcing agent layer, and a SUS plate at 23° C. and 50% RH, and at a tensile rate of 300 mm/min and a peel angle of 180°,
wherein the laminate shows an adhesive strength of 20 N/20 mm or more when the pressure-sensitive adhesive sheet is peeled from a laminated structural body of the pressure-sensitive adhesive sheet, the reinforcing agent layer, and a polycarbonate plate at 23° C. and 50% RH, and at a tensile rate of 300 mm/min and a peel angle of 180°,
wherein the laminate shows an adhesive strength of 20 N/20 mm or more when the pressure-sensitive adhesive sheet is peeled from a laminated structural body of the pressure-sensitive adhesive sheet, the reinforcing agent layer, and an aluminum plate at 23° C. and 50% RH, and at a tensile rate of 300 mm/min and a peel angle of 180°, and
wherein the laminated structural body of the pressure-sensitive adhesive sheet, the reinforcing agent layer, and the SUS plate shows an impact resistance of 0.35 J or more at 23° C. and 50% RH.

2. The laminate according to claim 1,
wherein the pressure-sensitive adhesive layer serving as the outermost layer of the pressure-sensitive adhesive sheet on the reinforcing agent layer side is formed from a pressure-sensitive adhesive composition,
wherein the pressure-sensitive adhesive composition contains at least one kind selected from the group consisting of a monomer composition (M) and a polymer component (P) obtained from the monomer composition (M), and
wherein the monomer composition (M) contains 50 wt % or more of a (meth)acrylic acid ester having an alkyl ester having 1 to 12 carbon atoms, and contains 1 wt % to 10 wt % of (meth)acrylic acid.

3. The laminate according to claim 2, wherein the monomer composition (M) contains 85 wt % or more of the (meth)acrylic acid ester having the alkyl ester having 1 to 12 carbon atoms.

4. The laminate according to claim 2, wherein the (meth)acrylic acid ester having the alkyl ester having 1 to 12 carbon atoms is n-butyl acrylate.

5. The laminate according to claim 1, wherein the pressure-sensitive adhesive sheet has a thickness of from 100 μm to 400 μm.

6. The laminate according to claim 1, wherein the reinforcing agent layer has a thickness of from 0.10 μm to 4.00 μm.

7. The laminate according to claim 1, wherein the reinforcing agent layer is formed from a reinforcing agent, and the reinforcing agent contains an aqueous urethane resin bonded by an isocyanate-based cross-linking agent, the resin having at least one kind selected from the group consisting of an ester skeleton, an ether skeleton, and a carbonate skeleton.

8. The laminate according to claim 7, wherein the aqueous urethane resin has an elongation of from 300% to 1,000%.

9. The laminate according to claim 7, wherein the aqueous urethane resin is a nonreactive aqueous urethane resin.

10. The laminate according to claim 9, wherein the nonreactive aqueous urethane resin is a self-emulsifying aqueous urethane resin.

11. The laminate according to claim 1, wherein the adherend is an electronic device member.

12. The laminate according to claim 1, wherein a material for an adhesion site of the adherend is at least one kind selected from the group consisting of SUS, polycarbonate, aluminum, a polyolefin-based resin, a styrene-based resin, a polyester-based resin, an acrylic resin, a polyimide-based resin, and a glass fiber.

13. The laminate according to claim 1, wherein the laminate is used for an electronic device.

14. A mobile electronic device, comprising the laminate of claim 1.
